(19) United States
(12) Patent Application Publication
(10) Pub. No.: US 2024/0089621 A1
(43) Pub. Date: Mar. 14, 2024

(54) IMAGING DEVICE

(71) Applicant: Panasonic Intellectual Property Management Co., Ltd., Osaka (JP)

(72) Inventors: YASUO MIYAKE, Osaka (JP); MAKOTO SHOUHO, Osaka (JP)

(21) Appl. No.: 18/508,277

(22) Filed: Nov. 14, 2023

Related U.S. Application Data
(63) Continuation of application No. PCT/JP2022/019062, filed on Apr. 27, 2022.

(30) Foreign Application Priority Data
Jun. 1, 2021 (JP) 2021-092623

(51) Int. Cl. H04N 25/59; H04N 25/771

(52) U.S. Cl. CPC H04N 25/59; H04N 25/771; H04N 25/65

(57) ABSTRACT

An imaging device includes a first pixel, a second pixel, and a correction circuit. First signals respectively corresponding to the first pixel and the second pixel are input to the correction circuit. The correction circuit outputs second signals in response to the first signals. Each of the first pixel and the second pixel includes a photoelectric converter, a charge storage region, and a capacitance circuit. The photoelectric converter converts light into signal charges. The charge storage region stores the signal charges. The capacitance circuit varies a capacitance value of the charge storage region in response to a potential of the charge storage region. The correction circuit corrects the first signal of at least one of the first pixel or the second pixel to the second signal in a case where the same amount of light is incident on the first pixel and the second pixel.

### BACKGROUND

### 1. Technical Field

The present disclosure relates to an imaging device.

### 2. Description of the Related Art

Stacked-type imaging devices as metal-oxide-semiconductor (MOS) imaging devices are disclosed. A typical stacked-type imaging device includes a photoelectric conversion film laminated on the outermost surface of a semiconductor substrate and accumulates, in a floating diffusion, charges that are generated in the photoelectric conversion film through photoelectric conversion. The imaging device reads the accumulated charges using a charge coupled device (CCD) circuit or a complementary MOS circuit in the semiconductor substrate. Japanese Unexamined Patent Application Publication No. 2009-164604 discloses such an imaging device.

### SUMMARY

One non-limiting and exemplary embodiment provides a technique appropriate to provide a wider dynamic range.

In one general aspect, the techniques disclosed here feature an imaging device including: a first pixel and a second pixel; and a correction circuit that receives first signals respectively corresponding to the first pixel and the second pixels and that outputs second signals in response to the first signals, wherein each of the first pixel and the second pixel includes: a photoelectric converter that converts light into signal charges; a charge storage region that stores the signal charges; and a capacitance circuit that varies a capacitance value of the charge storage region in response to a potential of the charge storage region, and the correction circuit corrects the first signal of at least one of the first pixel or the second pixel to the second signal such that a difference between the second signal of the first pixel and the second signal of the second pixel is less than a difference between the first signal of the first pixel and the first signal of the second pixel in a case where the same amount of light is incident on the first pixel and the second pixel.

The technique according to an aspect of the disclosure may provide a wider dynamic range.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is an exemplary schematic circuit diagram of an imaging device of a first embodiment;

FIG. 2 is an exemplary schematic circuit diagram of each pixel illustrated in FIG. 1;

FIG. 3 is a graph illustrating light exposure to pixel signal level characteristics in a first mode of the first embodiment;

FIG. 4 is a graph illustrating the light exposure to pixel signal level characteristics in a second mode of the first embodiment;

FIG. 5 is a graph illustrating adjustment of gamma characteristics;

FIG. 6 is a circuit block diagram illustrating signal processing of the first embodiment;

FIG. 7 is a graph illustrating variations in the light exposure to first signal level characteristics of each pixel according to a first example;

FIG. 8 is a correction table according to the first example;

FIG. 9 is a graph illustrating light exposure to second signal level characteristics at each control potential according to the first example;

FIG. 10 is a graph illustrating variations in the light exposure to first signal level characteristics at each control potential according to a second example;

FIG. 11 is a correction table according to the second example;

FIG. 12 is a graph illustrating variations in the light exposure to first signal level characteristics of each pixel at each control potential according to a third example;

FIG. 13A is a correction table of a signal of a first pixel according to the third example;

FIG. 13B is a correction table of a signal of a second pixel according to the third example;

FIG. 13C is a correction table of a signal of a third pixel according to the third example;

FIG. 14 is a graph illustrating variations in the light exposure to first signal level characteristics of each pixel according to a fourth example;

FIG. 15 is a correction table according to the fourth example;

FIG. 16 is a graph illustrating variations in the light exposure to first signal level characteristics of each pixel according to a fifth example;

FIG. 17 is a correction table according to the fifth example;

FIG. 18A is an exemplary schematic circuit diagram of a pixel of a second embodiment;

FIG. 18B is an exemplary schematic circuit diagram of a pixel of another example of the second embodiment;

FIG. 19 is an exemplary schematic circuit diagram of a pixel of a third embodiment;

FIG. 20 is a graph illustrating light exposure to pixel signal level characteristics in a second mode according to the third embodiment;

FIG. 21 is an exemplary schematic circuit diagram of a pixel according to another example of the third embodiment;

FIG. 22 is a graph illustrating the light exposure to first signal level characteristics of each pixel according to a sixth example;

FIG. 23A is a correction table of a signal of the first pixel according to the sixth example;

FIG. 23B is a correction table of a signal of the second pixel according to the sixth example;

FIG. 24 is a graph illustrating variations in the light exposure to first signal level characteristics at each control potential according to a seventh example;

FIG. 25 is a correction table of according to the seventh example;

FIG. 26 is a graph illustrating variations in the light exposure to first signal level characteristics of each pixel at each gain according to an eighth example;

FIG. 27A is a correction table at gain 1 according to the eighth example;

FIG. 27B is a correction table at gain 2 according to the eighth example;

FIG. 28 is a graph illustrating variations in the light exposure to first signal level characteristics at each temperature according to a ninth example;

FIG. 29 is a correction table according to the ninth example;

FIG. 30 is a circuit block diagram illustrating signal processing of a first specific example;

FIG. 31 is a circuit block diagram illustrating signal processing of a second specific example;

FIG. 32 is a flow chart according to a first acquisition example;

FIG. 33 is a flow chart according to a second acquisition example;

FIG. 34 is a flow chart according to a third acquisition example;

FIG. 35 is an exemplary schematic circuit diagram of an imaging device of a fourth embodiment;

FIG. 36 is an exemplary schematic circuit diagram of a pixel illustrated in FIG. 35;

FIG. 37 is an exemplary schematic circuit diagram of a pixel according to a fifth embodiment;

FIG. 38 is an exemplary schematic circuit diagram of a pixel according to a sixth embodiment;

FIG. 39 is an exemplary schematic circuit diagram of a pixel according to a seventh embodiment;

FIG. 40 is an exemplary schematic circuit diagram of a pixel according to an eighth embodiment;

FIG. 41 is an exemplary schematic circuit diagram of a pixel according to a ninth embodiment;

FIG. 42 is an exemplary schematic circuit diagram of a pixel according to another embodiment;

FIG. 43 is an exemplary schematic circuit diagram of a second stage of a pixel;

FIG. 44 is an exemplary schematic circuit diagram of a pixel according to another embodiment; and

FIG. 45 is an exemplary schematic circuit diagram of a pixel according to another embodiment.

### DETAILED DESCRIPTIONS

### Outlook of a First Aspect of the Disclosure

According to a first aspect of the disclosure, there is provided an imaging device including:

a first pixel and a second pixel; and

a correction circuit that receives first signals respectively corresponding to the first pixel and the second pixels and that outputs second signals in response to the first signals,

wherein each of the first pixel and the second pixel includes:

a photoelectric converter that converts light into signal charges;

a charge storage region that stores the signal charges; and

a capacitance circuit that varies a capacitance value of the charge storage region in response to a potential of the charge storage region, and

the correction circuit corrects the first signal of at least one of the first pixel or the second pixel to the second signal such that a difference between the second signal of the first pixel and the second signal of the second pixel is less than a difference between the first signal of the first pixel and the first signal of the second pixel in a case where the same amount of light is incident on the first pixel and the second pixel.

The first aspect may be appropriate to provide a wider dynamic range.

According to a second aspect of the disclosure, in the imaging device related to the first aspect, the correction circuit may correct the first signal of at least one of the first pixel or the second pixel to the second signal such that the second signal is linear with respect to an amount of incident light.

The second aspect may facilitate processing the second signal at a second stage of the correction circuit.

According to a third aspect of the disclosure, in the imaging device of one of the first aspect and the second aspect, the capacitance circuit may include:

a first voltage supply circuit; and

a first transistor and a first capacitor that are connected in series between the first voltage supply circuit and the charge storage region, and

a gate of the first transistor may be connected to the charge storage region.

The third aspect may provide a configuration example that allows the capacitance value of the charge storage region to vary in response to the potential of the charge storage region.

According to a fourth aspect of the disclosure, in the imaging device of the third aspect, the first voltage supply circuit, the first capacitor, the first transistor, and the charge storage region may be connected in series in this order.

The fourth aspect may provide a configuration example that allows the capacitance value of the charge storage region to vary in response to the potential of the charge storage region.

According to a fifth aspect of the disclosure, in the imaging device of the third aspect, the first voltage supply circuit, the first transistor, the first capacitor, and the charge storage region may be connected in series in this order.

The fifth aspect may provide a configuration example that allows the capacitance value of the charge storage region to vary in response to the potential of the charge storage region.

According to a sixth aspect of the disclosure, in the imaging device of one of the first aspect and the second aspect, the capacitance circuit may include:

a first voltage supply circuit; and

a metal-oxide-semiconductor (MOS) capacitor that is connected between the first voltage supply circuit and the charge storage region.

The sixth aspect may provide a configuration example that allows the capacitance value of the charge storage region to vary in response to the potential of the charge storage region.

According to a seventh aspect of the disclosure, in the imaging device one of the first through sixth aspects,

the correction circuit may correct the first signal of at least one of the first pixel or the second pixel to the second signal by using a correction table that associates the first signal with the second signal.

The first signal may be corrected to the second signal in accordance with the correction table of the seventh aspect.

According to an eighth aspect of the disclosure, in the imaging device of one of the first through sixth aspects, the correction circuit may correct the first signal of at least one of the first pixel or the second pixel to the second signal by using a function that defines a relationship between the first signal and the second signal.

The first signal may be corrected to the second signal in accordance with the function of the eighth aspect.

According to a ninth aspect of the disclosure, there is provided a signal processing method outputting second signals in response to first signals respectively corresponding to a first pixel and a second pixel,

each of the first pixel and the second pixel including a capacitance circuit that varies, in response to a potential of a charge storage region that stores signal charges, a capacitance value of the charge storage region, the signal processing method including:

inputting the first signals respectively corresponding to the first pixel and the second pixel;

correcting the first signal of at least one of the first pixel or the second pixel to the second signal such that a difference between the second signal of the first pixel and the second signal of the second pixel is less than a difference between the first signal of the first pixel and the first signal of the second pixel in a case where the same amount of light is incident on the first pixel and the second pixel; and

outputting the second signals respectively corresponding to the first pixel and the second pixel.

The ninth aspect may be appropriate to provide a wider dynamic range.

According to a tenth aspect of the disclosure, the signal processing method of the ninth aspect may further include

correcting the first signal of at least one of the first pixel or the second pixel to the second signal such that the second signal is linear with respect to an amount of incident light.

The tenth aspect may facilitate processing the second signal at the second stage of the correction circuit.

According to an eleventh aspect of the disclosure, there is provided an imaging device including:

a first pixel; and

a correction circuit that receives a first signal corresponding to the first pixel and outputs a second signal in response to the first signal,

wherein the first pixel includes:

a photoelectric converter that converts light into signal charges;

a charge storage region that stores the signal charges; and

a capacitance circuit that varies a capacitance value of the charge storage region in response to a potential of the charge storage region, and

the correction circuit corrects the first signal of the first pixel to the second signal such that the second signal is linear with respect to an amount of incident light.

The eleventh aspect may be appropriate to provide a wider dynamic range.

According to a twelfth aspect of the disclosure, there is provided an imaging device including:

a first pixel; and

a correction circuit that receives a first signal corresponding to the first pixel and outputs a second signal in response to the first signal,

wherein the first pixel includes:

a photoelectric converter that converts light into signal charges;

a charge storage region that stores the signal charges; and

a capacitance circuit that varies a capacitance value of the charge storage region in response to a potential of the charge storage region, and

if a relationship of a pixel signal with an amount of incident light is defined as output characteristics, the output characteristics of the first pixel include first characteristics and second characteristics, and

the correction circuit corrects the first signal of at least one of the first pixel having the first characteristics or the first pixel having the second characteristics to the second signal such that a difference between the second signal of the first pixel having the first characteristics and the second signal of the first pixel having the second characteristics is less than a difference between the first signal of the first pixel having the first characteristics and the first signal of the first pixel having the second characteristics in a case where the same amount of light is incident on the first pixel having the first characteristic and the first pixel having the second characteristics.

The twelfth aspect may be appropriate to provide a wider dynamic range. According to the twelfth aspect, the output characteristics may vary in accordance with a control potential applied to the capacitance circuit, a temperature of the capacitance circuit, and the like.

In the discussion of embodiments, the terms “above” and “below” are simply used to define a layout location of members and does not intend to limit the posture of the imaging device in use.

According to embodiments, a modification of each element responsive to a difference between positive signal charges and negative signal charges, for example, responsive to a change of conductivity type of an impurity region may be appropriately performed.

According to the embodiments, the “source” of a transistor and the “drain” of the transistor may be interchangeably used. For example, which of two impurity regions of a metal oxide semiconductor field-effect transistor (MOSFET) corresponds to the source or the drain may be determined depending on the polarity of the MOSFET and whether a potential is higher or lower at the moment of interest. For this reason, which of the two impurity regions is the source or the drain may be changed depending on the operating condition of the MOSFET.

The term “node” is used in the discussion of the embodiments. The node refers to the concept indicating a junction between multiple elements in an electric circuit and including a wiring that connects the elements.

According to the embodiments, the terms “illumination” and “light exposure” are used. The illumination refers to a luminous flux that is incident on a unit area. The light exposure refers to a time integral value of the luminous flux incident on a target that is exposed to light.

According to the embodiments, an expression reading “an element A is connected to an element B” is used. This expression also refers to a configuration that part or whole of the element A is included in the element B.

The embodiments of the disclosure are specifically described with reference to the drawings.

### FIRST EMBODIMENT

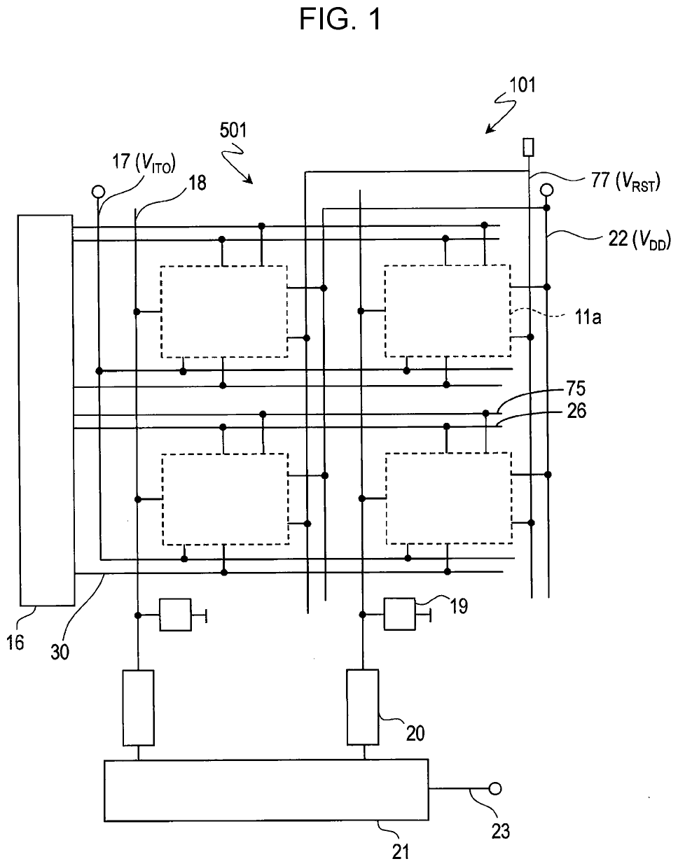

FIG. 1 is an exemplary schematic circuit diagram of an imaging device 101 of a first embodiment. The imaging device 101 illustrated in FIG. 1 includes multiple pixels 11a and peripheral circuits.

The pixels 11a are arranged two-dimensionally on a semiconductor substrate and thus forms a pixel array 501. The semiconductor substrate is, for example, a silicon substrate. As illustrated in FIG. 1, the pixels 11a are arranged in a row direction and a column direction. The pixels 11a may also be arranged one-dimensionally as a line sensor.

Each pixel 11a is connected to a power supply line 22. The pixel 11a is supplied with a power supply potential V_{DD} via the power supply line 22.

Each pixel 11a of the first embodiment includes a photoelectric converter arranged above a semiconductor substrate. All the photoelectric converters are supplied with a potential V_{ITO} via an accumulation control line 17.

Each pixel 11a is connected to a reset voltage line 77. Each pixel 11a is supplied with a reset potential V_{RST} via the reset voltage line 77.

The peripheral circuits include a vertical scanning circuit 16, a load circuit 19, a column signal processing circuit 20, and a horizontal signal reading circuit 21. The column signal processing circuit 20 and the load circuit 19 are arranged on each column of the pixels 11a.

An address signal line 30 is arranged on each row of the pixels 11a. Each pixel 11a is connected to the vertical scanning circuit 16 via the corresponding address signal line 30. The vertical scanning circuit 16 selects, on a per row unit basis, multiple pixels 11a arranged on each row by applying a predetermined potential to the address signal line 30. The pixel signals are thus read from the selected pixels 11a.

A reset signal line 26 is arranged on each row of the pixels 11a. Each row of the pixels 11a is connected to the vertical scanning circuit 16 via the reset signal line 26. A reset transistor 36 is turned on or off by controlling the potential of the reset signal line 26.

A specific reset signal line 75 is arranged on each row of the pixels 11a. Each row of the pixels 11a is connected to the vertical scanning circuit 16 via the corresponding specific reset signal line 75. A specific reset transistor 76 is turned on or off by controlling the potential of the specific reset signal line 75.

A vertical signal line 18 is arranged on each column of the pixels 11a. Each column of the pixels 11a is connected to the corresponding vertical signal line 18. The load circuit 19 is arranged on each vertical signal line 18. Each load circuit 19 is connected to the vertical signal line 18.

The column signal processing circuit 20 is arranged on each vertical signal line 18. Each column signal processing circuit 20 is connected to the corresponding vertical signal line 18. The column signal processing circuit 20 performs a noise suppression signal processing operation and an analog-to-digital (AD) conversion operation. The noise suppression signal processing operation is, for example, correlated double sampling. Multiple column signal processing circuits 20 are connected to the horizontal signal reading circuit 21. The horizontal signal reading circuit 21 successively reads signals from the column signal processing circuits 20 onto a horizontal common signal line 23.

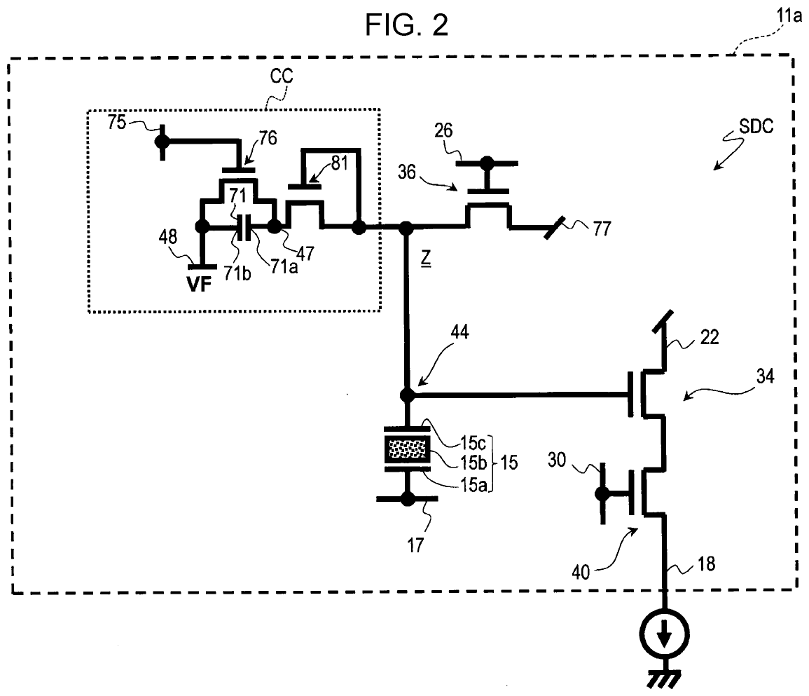

FIG. 2 illustrates an exemplary circuit configuration of the pixel 11a in FIG. 1.

The pixel 11a includes a photoelectric converter 15. The photoelectric converter 15 converts light into electric charges. In the following discussion, the electric charge may also be referred to as a signal charge.

According to the first embodiment, the photoelectric converter 15 includes a counter electrode 15a, a photoelectric conversion layer 15b, and a pixel electrode 15c. The photoelectric conversion layer 15b is arranged between the counter electrode 15a and the pixel electrode 15c.

The photoelectric conversion layer 15b is laminated on a semiconductor substrate. The material of the photoelectric conversion layer 15b may be organic or inorganic. For example, the inorganic material may be amorphous silicon. The photoelectric conversion layer 15b may include a layer manufactured of an organic material and a layer manufactured of an inorganic material. Typically, the photoelectric conversion layer 15b has a film-like structure.

The counter electrode 15a is arranged on a light-incident surface of the photoelectric conversion layer 15b. Light is incident on the photoelectric conversion layer 15b via the counter electrode 15a. Typically, the material of the counter electrode 15a is a transparent conductive material, such as indium tin oxide (ITO).

The pixel electrode 15c faces the counter electrode 15a with the photoelectric conversion layer 15b therebetween. The pixel electrode 15c collects signal charges generated through photoelectric conversion performed by the photoelectric conversion layer 15b. The material of the pixel electrode 15c is a metal, a metal compound, or polysilicon. The metal may be aluminum, copper or the like. The metal compound may be metal nitride. Polysilicon is doped with an impurity to be imparted with conductivity.

The counter electrode 15a is connected to the accumulation control line 17.

The counter electrode 15a is supplied with the potential V_{ITO} via the accumulation control line 17. The photoelectric conversion layer 15b generates hole-electron pairs and either holes or electrons are collected as the signal charges by the pixel electrode 15c.

If holes are used as the signal charges, the potential V_{ITO} is set such that the potential of the counter electrode 15a is higher than the potential of the pixel electrode 15c. In the following discussion, holes are used as the signal charges. Alternatively, however, electrons may be used as the signal charges.

The pixel electrode 15c is connected to a charge holding node 44. In the specification, the charge holding node 44 is part of a charge storage region Z that stores the signal charges collected by the pixel electrode 15c. The charge storage region Z includes an electrode connected to the charge holding node 44, transistors, and capacitance elements.

The pixel 11a includes a signal detection circuit SDC. The signal detection circuit SDC includes an amplification transistor 34, an address transistor 40, and a reset transistor 36.

One of the source and the drain of the reset transistor 36 is connected to the charge holding node 44. The other of the source and the drain of the reset transistor 36 is connected to the reset voltage line 77.

The gate of the amplification transistor 34 is connected to the charge holding node 44. One of the source and the drain of the amplification transistor 34 is connected to the power supply line 22. The other of the source and the drain of the amplification transistor 34 is connected to one of the source and the drain of the address transistor 40. The other of the source and the drain of the address transistor 40 is connected to the vertical signal line 18. The gate of the address transistor 40 is connected to the address signal line 30.

As illustrated in FIG. 2, the power supply line 22 serves as a source follower power supply. The load circuit 19 illustrated in FIG. 1 and the amplification transistor 34 form a source follower circuit. The amplification transistor 34 outputs a pixel signal responsive to an amount of signal charges accumulated in the charge storage region Z. The pixel signal is selectively read by the address transistor 40. Specifically, the pixel signal is a signal voltage.

The reset transistor 36 resets the potential of the charge storage region Z. Specifically, when the reset transistor 36 is turned on, the reset potential V_{RST} is supplied to the charge storage region Z from the reset voltage line 77 via the reset transistor 36. In this way, the charge storage region Z is reset in potential.

The pixel 11a includes a capacitance circuit CC. The capacitance circuit CC includes a first voltage supply circuit 48, a first capacitive element 71, a first transistor 81, and a specific reset transistor 76. The first capacitive element 71 includes a first terminal 71a, a second terminal 71b, and a dielectric layer. According to the first embodiment, the first capacitive element 71 is a metal-insulator-metal (MIM) capacitance and/or a metal oxide metal (MOM) capacitance.

The source of the first transistor 81 is also referred to as a first source. The drain of the first transistor 81 is also referred to as a first drain. The gate of the first transistor 81 is also referred to as a first gate.

In the first embodiment, the first gate is connected to the charge holding node 44. One of the first source and the first drain is connected to the charge holding node 44. The other of the first gate and the first drain is connected to the first terminal 71a. The second terminal 71b is connected to the first voltage supply circuit 48. The first transistor 81 and the first capacitive element 71 are connected in series between the first voltage supply circuit 48 and the charge storage region Z. Specifically, the first voltage supply circuit 48, the first capacitive element 71, the first transistor 81, and the charge storage region Z are connected in series in this order. The first gate of the first transistor 81 is connected to the charge storage region Z. The first voltage supply circuit 48 supplies a control potential VF to the second terminal 71b of the first capacitive element 71.

The first voltage supply circuit 48 may be included or external to the vertical scanning circuit 16. The same is true of a first voltage supply circuit 48a, a second voltage supply circuit 48b, and a third voltage supply circuit 48c described below.

In the first embodiment, a node connected to the other of the first source and the first drain of the first transistor 81 and the first terminal 71a of the first capacitive element 71 is also referred to as a node 47.

In the first embodiment, the control potential VF is a direct-current potential. The control potential VF may be different from time duration to time duration. For example, the control potential VF may be varied depending on an operation mode.

The capacitance circuit CC varies a capacitance value of the charge storage region Z in response to the potential of the charge storage region Z. This configuration is appropriate to provide a wider dynamic range.

The gate-source voltage of the first transistor 81 varies depending on the potential of the charge storage region Z. When the potential of the charge storage region Z varies across a first threshold potential, the first transistor 81 is turned on. In this way, the first capacitive element 71 is electrically connected to the charge holding node 44. The first capacitive element 71 then functions as part of the charge storage region Z, increasing the capacitance value of the charge storage region Z. The threshold potential of the charge storage region Z at which the first transistor 81 is turned on may thus be controlled by the control potential VF.

The capacitance value of the first capacitive element 71 may be higher than a capacitance value of the charge storage region Z with the first transistor 81 turned off.

In the first embodiment, each of the amplification transistor 34, the reset transistor 36, the address transistor 40, the first transistor 81, and the specific reset transistor 76 is a metal-oxide-semiconductor field-effect transistor (MOSFET), specifically N-channel MOSFET. Alternatively, however, these transistors may be P-channel MOSFETs. The transistors may not necessarily be all N-channel MOSFETs or all P-channel MOSFETs. The same is true of a feedback transistor 38, a second transistor 82, a third transistor 83, and other transistors described below.

In the first embodiment, the first voltage supply circuit 48 may switch an imaging mode by varying a first threshold potential. For example, by setting the first threshold potential to a relatively higher value, the first voltage supply circuit 48 may select a first mode in which the first transistor 81 remains continuously turned off and by setting the first threshold potential to a relatively lower value, the first voltage supply circuit 48 may select a second mode in which the first transistor 81 is turned on or off in response to the potential of the charge storage region Z. In such a case, the second mode may be a higher saturated and lower sensitivity mode than the first mode.

In the first embodiment, the first transistor 81 is turned on in response to the potential of the charge storage region Z in the second mode. The capacitance value of the charge storage region Z thus increases. On the other hand, the first transistor 81 remains continuously turned off in the first mode. For this reason, no increase occurs in the capacitance value of the charge storage region Z attributed to the first capacitive element 71.

Pseudo gamma characteristics may be obtained in the pixel 11a in the second mode. The status in which the imaging mode is the second mode may be referred to as “auto gamma ON.” On the other hand, in the first mode, the control potential VF in the capacitance circuit CC is set such that the capacitance value of the charge storage region Z remains unchanged. The status in which the imaging mode is the first mode may be referred to as “auto gamma OFF.” Controlling the control potential VF may thus switch between the auto gamma ON and the auto gamma OFF.

Signals obtained in the first mode and the second mode are further described.

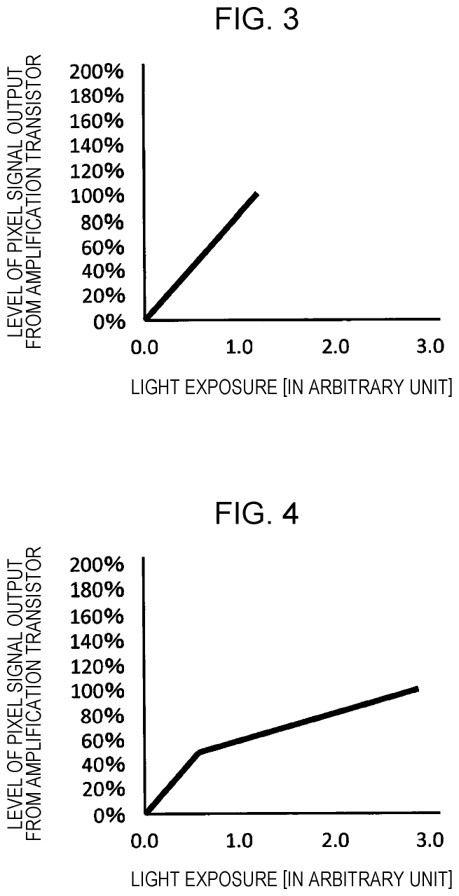

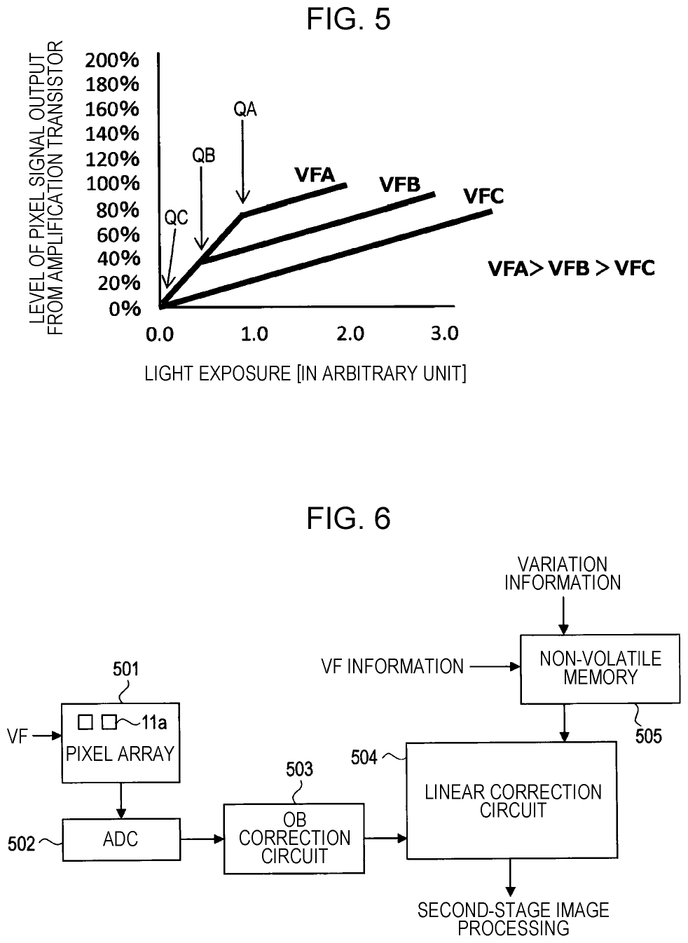

FIG. 3 is a graph illustrating light exposure to pixel signal level characteristics in the first mode. The abscissa of the graph represents a light exposure of the pixel 11a. The ordinate represents the level of the pixel signal output from the amplification transistor 34. The values on the abscissa and the ordinate are standardized. The same is true of FIGS. 4 and 5 described below. Referring to FIG. 3, the level of the pixel signal output from the amplification transistor 34 continuously increases in the first mode as the light exposure increases. At the light exposure at 1, an increase in the signal level reaches the limit thereof.

FIG. 4 is a graph illustrating the light exposure to pixel signal level characteristics in the second mode. The increase in the pixel signal level output from the amplification transistor 34 starts to be slower in the second mode when the light exposure increases beyond a threshold light exposure. This is because the capacitance value of the charge storage region Z is higher in the region where the light exposure is equal to or above the threshold light exposure and a variation in the potential of the charge storage region Z is more gradual.

As seen from FIGS. 3 and 4, the signal charges may be accumulated on the charge storage region Z to a higher light exposure region in the second mode than in the first mode. This signifies that the pixel signal responsive to the light exposure is generated up to a higher light exposure region. Specifically, the dynamic range may be increased.

Referring to FIG. 4, when the first transistor 81 is turned on, the first capacitive element 71 turns active as a capacitance and the first terminal 71a of the first capacitive element 71 comes to function as part of the charge storage region Z storing the signal charges. This leads to an increase in the capacitance value of the charge storage region Z. Specifically, the capacitance value of the first capacitive element 71 is added as a capacitance value of the charge storage region Z.

The adjustment of the control potential VF may adjust the gamma characteristics. FIG. 5 is a graph illustrating the adjustment of the gamma characteristics. FIG. 5 illustrates the cases in which the control potential VF is set to a potential VFA, a potential VFB, and a potential VFC.

The potential VFA is higher than the potential VFB and the potential VFB is higher than the potential VFC. The threshold light exposure with the control potential VF set to the potential VFA is a light exposure QA. The threshold light exposure with the control potential VF set to the potential VFB is a light exposure QB. The threshold light exposure with the control potential VF set to the potential VFC is a light exposure QC. The light exposure QA is higher than the light exposure QB and the light exposure QB is higher than the light exposure QC.

In a dark scene, by setting the control potential VF to the potential VFA, sufficient gradations or a sufficient number of bits may be assigned to the region where the light exposure is lower. In a bright scene, by setting the control potential VF to the potential VFC, sufficient gradations or a sufficient number of bits may be assigned to the region where the light exposure is higher.

### Signal Processing

FIG. 6 is a circuit block diagram illustrating signal processing according to the first embodiment. The signal processing is described below with reference to FIG. 6.

In the pixel array 501, an analog pixel signal at a level responsive to the light exposure of the pixel 11a is output from the pixel 11a. The light exposure to pixel signal level characteristics may have gamma characteristics illustrated in FIG. 4 or other figures.

An analog-to-digital (AD) conversion circuit 502 coverts the pixel signal into a first signal. In the first embodiment, the AD conversion circuit 502 is included in the column signal processing circuit 20.

The imaging device 101 includes an optical black (OB) pixel that is not illustrated. The OB correction circuit 503 performs OB correction on a first signal using the OB pixel. The OB correction calculates a difference between the first signal and the signal output from the OB pixel. The black levels of the first signals are aligned by performing the OB correction on the first signals of the multiple pixels 11a.

The correction circuit 504 corrects the first signal to a second signal. According to the first embodiment, the first signal to be corrected to the second signal may be a signal that has undergone the OB correction. However, the OB correction may not necessarily be performed. The first signal to be corrected to the second signal may be a signal that has not undergone the OB correction.

In the first embodiment, the correction circuit 504 is a linear correction circuit. The correction performed by the correction circuit 504 is linear correction. By performing the linear correction on the first signal, the signal from the pixel 11a may be improved in linearity. In this sense, the linearity refers to the linearity of the signal level with respect to the light exposure of the pixel 11a.

If the light exposure increases beyond the threshold light exposure in the graph representing the light exposure to pixel signal level characteristics, an increase in the pixel signal level becomes more gradual. In other words, the gradient of the graph line the graph changes at the threshold light exposure. The same is true of light exposure to first signal level characteristics representing a relationship of the level of the first signal with respect to the light exposure of the pixel 11a.

Manufacturing variation may cause variations in the characteristics of the multiple pixels 11a. The variations in the characteristics of the pixels 11a may cause variations in the light exposure to first signal level characteristics. For example, the threshold light exposure may vary. Also, variations may cause variations in the gradients of graph lines representing the light exposure to pixel signal level characteristics. As described above, the correction circuit 504 corrects the first signal to the second signal. The correction may reduce the variations in the light exposure to signal level characteristics.

In the first embodiment, the correction of the first signal to the second signal is a linear correction. Typically, the graph line of the gamma characteristics is free from bending and the linearity of the signal level with respect to the light exposure of the pixel 11a is ensured.

In the first embodiment, the correction circuit 504 corrects the first signal to the second signal in accordance with a correction table. The correction table associates the first signal with the second signal on each pixel 11a.

Referring to FIG. 6, a non-volatile memory 505 stores the correction table.

Specifically, the non-volatile memory 505 stores multiple pairs of the values of corresponding first signals and second signals. The correction table thus lists the multiple pairs of the signal values. The correction circuit 504 corrects the first signal to the second signal by reading the correction table on the non-volatile memory 505.

Referring to FIG. 6, variation information is directed to the non-volatile memory 505 as illustrated by an arrow. This signifies that the variations in the characteristics of the pixels 11a are reflected on the correction table on the non-volatile memory 505. The variation in the characteristics may be identified by acquiring in advance, with a uniform light source, a relationship between the first signal and the light exposure of each pixel 11a.

The light exposure to first signal level characteristics of the pixel 11a may vary in response to the control potential VF. Specifically, the threshold light exposure may vary in response to the control potential VF. The correction table may convert the light exposure to first signal level characteristics having dependency on the control potential VF to the light exposure to second signal level characteristics having reduced dependency on the control potential VF.

Referring to FIG. 6, VF information is directed to the non-volatile memory 505. This signifies that the control potential VF is reflected on the correction table on the non-volatile memory 505. The VF information signifies that a corresponding relationship between the values of the first signal and the second signal in the correction table is responsive to the control potential VF.

In the first embodiment, the second signal obtained from the correction circuit 504 is image-processed at a second stage of the correction circuit 504. The second-stage image processing includes white balance gain processing, gamma processing, color complement processing, and the like.

The correction of the first signal to the second signal may not necessarily be performed on signals from all the pixels 11a. In view of this, the correction of the first embodiment may be described as below. In the following discussion, each of the first pixel and the second pixel may be any of the pixels 11a. An amount of light incident on the first pixel is the light exposure to the first pixel. An amount of light incident on the second pixel is the light exposure to the second pixel.

In the first embodiment, first signals respectively corresponding to the first pixel and the second pixel are input to the correction circuit 504. If the same amount of light is incident on the first pixel and the second pixel, the first signal of at least one of the first pixel or the second pixel is corrected to the second signal such that a difference between the second signal of the first pixel and the second signal of the second pixel is less than a difference between the first signal of the first pixel and the first signal of the second pixel. The correction circuit 504 outputs the second signals corresponding to the first pixel and the second pixel. In this configuration, the correction may set the characteristics of a signal from the first pixel responsive to an amount of light incident on the first pixel to be closer to the characteristics of a signal from the second pixel responsive to an amount of light incident on the second pixel. In this context, the difference between the signals signifies a difference between intensities of the signals.

The effect of the correction circuit 504 in the configuration described above is further described below. The capacitance circuit CC in the first embodiment causes the capacitance of the charge storage region Z to vary in response to the potential of the charge storage region Z. Such capacitance circuit CC may provide a wider dynamic range. However, the study made by the inventors indicates that the variation in the output characteristics of the capacitance circuit CC may lead to a roughness in images and a determination error in image sensing. The correction performed by the correction circuit 504 sets the signal characteristics of the first pixel to be closer to the signal characteristics of the second pixel. Even with the variation in the output characteristics of the capacitance circuit CC, the correction circuit 504 may cause the roughness in the images and the determination error in the image sensing to be less likely to occur.

Specifically, the correction circuit 504 corrects the first signal of at least one of the first pixel or the second pixel to the second signal such that the second signal is linear with respect to an amount of incident light. In this configuration, processing of the second signal at the second stage of the correction circuit 504 may be facilitated.

The expression “second signal is linear with respect to the amount of incident light” is described further. If two-valued variable data representing the value of an amount of incident light and the value of the second signal is obtained, a regression line may be calculated in accordance with the least-square method of the two-valued variable data. According to the first embodiment, the expression signifies that squared R² of the correlation coefficient of the regression line is 0.7 or larger. The expression is not intended to define whether the first signal is linear or non-linear but focuses on the linearity of the second signal. The expression also signifies that the second signal of the first pixel is linear with respect to the amount of light incident on the first pixel and that the second signal of the second pixel is linear with respect to the amount of light incident on the second pixel. The regression line is calculated in accordance with the least-square method of the two-valued variable data of the value of the amount of incident light and the value of the first signal and the squared R² of the correlation coefficient of the regression line may be 0.8 or larger or 0.9 or larger or 1.

The effects of the correction circuit 504 are further described. A signal responsive to an amount of incident light may now be non-linear. When signal processing, such as the white balance adjustment and interpolation between colors of the pixels, is performed on the non-linear signal, controlling the deterioration of image quality, such as coloration, may not be easy. According to the correction described above, however, linearity of the signal in the signal processing may be ensured. This may facilitate the signal processing while controlling the deterioration of the image quality.

In the first embodiment, the correction circuit 504 corrects the first signal of at least one of the first pixel or the second pixel to the second signal in accordance with the correction table. The correction table associates the first signal with the second signal.

A specific example of the correction using the correction table is described with reference to the drawings.

Case in which Variation occurs in Element Characteristics of Capacitance Circuit between Pixels

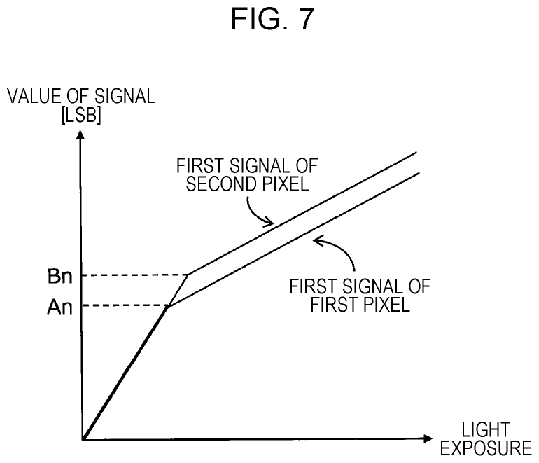

FIG. 7 is a graph illustrating variations in the light exposure to first signal level characteristics of each pixel according to a first example. In the graph in FIG. 7, the abscissa represents the light exposure of the pixels. The ordinate represents the value of the signal. The same is true of the abscissa and the ordinate described below. The two graph lines of the first example are related to two pixels 11a. The two pixels 11a are referred to as a first pixel and a second pixel.

FIG. 7 indicates the situation in which a variation occurs in the threshold voltage of the first transistor 81 between the first pixel and the second pixel. The variation in the threshold voltage causes a variation in the threshold light exposure of the light exposure to first signal level characteristics. In this context, the threshold voltage is a gate-source voltage of a transistor when the transistor is turned on.

Referring to FIG. 7, An on the ordinate is the value of the first signal corresponding to the threshold light exposure in the light exposure to first signal level characteristics of the first pixel. Bn on the ordinate is the value of the first signal corresponding to the threshold light exposure in the light exposure to first signal level characteristics of the second pixel.

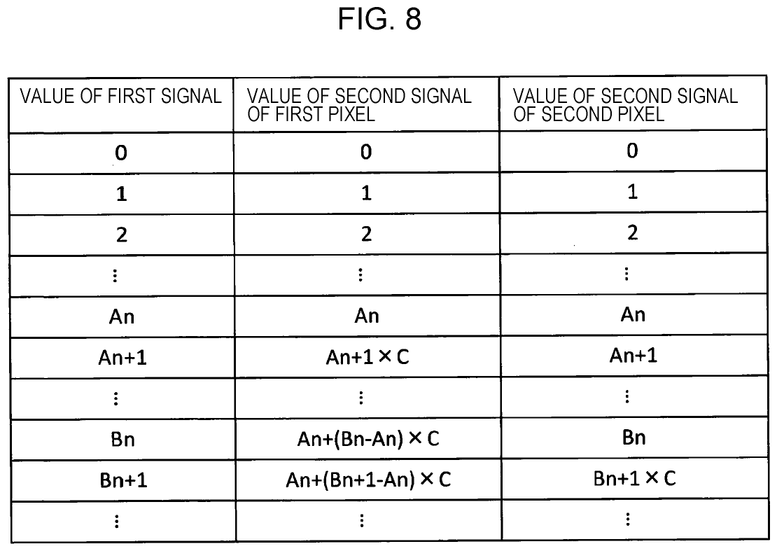

FIG. 8 is the correction table of the first example. Specifically, the correction table is a linear correction table. The same is true of second to ninth examples described below.

The left column of the correction table in FIG. 8 lists values of first signals of the first pixel and the second pixel. The middle column lists the values of the second signals of the first pixel. The right column lists the values of the second signals of the second pixel. The correction table associates the value of the first signal of the first pixel with the value of the second signal of the first pixel. The correction table also associates the value of the first signal of the second pixel with the value of the second signal of the second pixel.

In the region where the value of the first signal of the first pixel is equal to or above 0 and equal to or below An, the first signal of the first pixel is equal to the second signal of the first pixel. In the region where the value of the first signal of the first pixel is above An, the value of the second signal of the first pixel is (An+(X−An)×C) if the value of the first signal of the first pixel is X. Herein, C is a correction factor. As illustrated in FIG. 8, the description with the “first pixel” and “An” respectively interchanged with the “second pixel” and “Bn” also holds true.

With reference to FIG. 7, a variation may occur in the threshold light exposure of the light exposure to first signal level characteristics between the first pixel and the second pixel. Even in such a case, the correction in accordance with the correction table in FIG. 8 may align the light exposure to second signal level characteristics between the first pixel and the second pixel. The linearity of the light exposure to second signal level characteristics in each pixel may be ensured.

In the correction table in FIG. 8, the value of the first signal entered into the correction table may be equal to the value of the second signal output from the correction table. In the first embodiment, such a case is also treated as a case in which the first signal has been corrected to the second signal. In other words, if the signal from the pixel is obtained via the correction table, it is considered that the correction table has corrected the first signal to the second signal. More typically, if the signal from the pixel is obtained via the correction circuit 504, it is considered that the correction circuit 504 has corrected the first signal to the second signal.

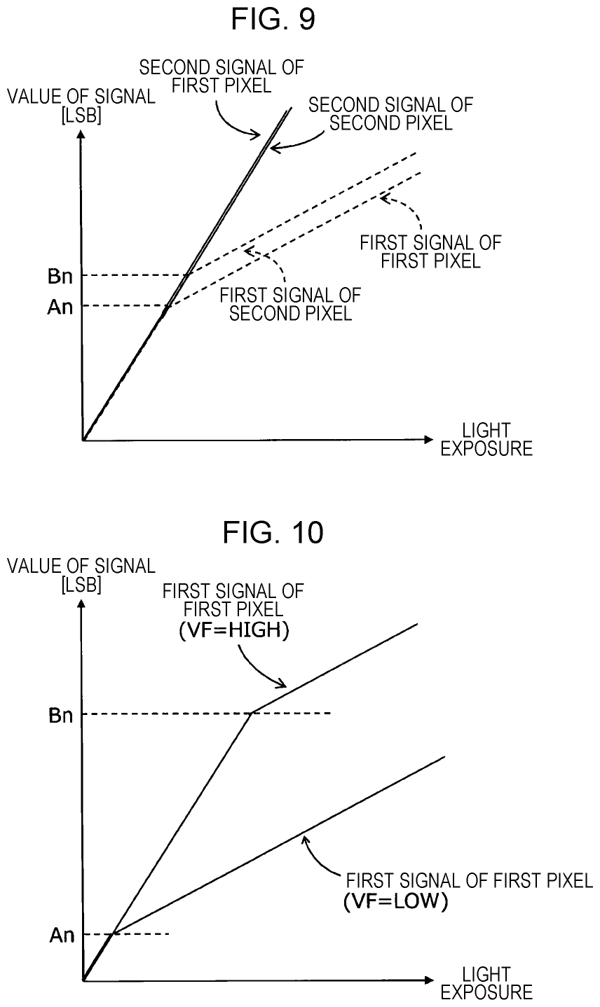

FIG. 9 is a graph illustrating the light exposure to second signal level characteristics of each pixel according to the first example. As illustrated in FIG. 9, the solid line represents the light exposure to second signal level characteristics. In FIG. 9, the broken lines represent the light exposure to first signal level characteristics. Case in which Control Potential VF is varied

FIG. 10 is a graph illustrating a variation in the light exposure to first signal level characteristics at each control potential VF according to a second example. The two graph lines in FIG. 10 are related to a single pixel 11a. The pixel 11a is hereinafter referred to as a first pixel.

Referring to FIG. 10, “VF=LOW” represents that the control potential VF applied to the first pixel is relatively low. “VF=HIGH” represents that the control potential VF applied to the first pixel is relatively high. As illustrated in FIG. 10, if the control potential VF is relatively low, the threshold light exposure is also relatively low. If the control potential VF is relatively high, the threshold light exposure is relatively high. The same is true of the drawings described below.

Referring to FIG. 10, An on the ordinate is the value of the first signal responsive to the threshold light exposure in the light exposure to first signal level characteristics of the first pixel with VF=LOW. Bn on the ordinate is the value of the first signal responsive to the threshold light exposure in the light exposure to first signal level characteristics with VF=HIGH.

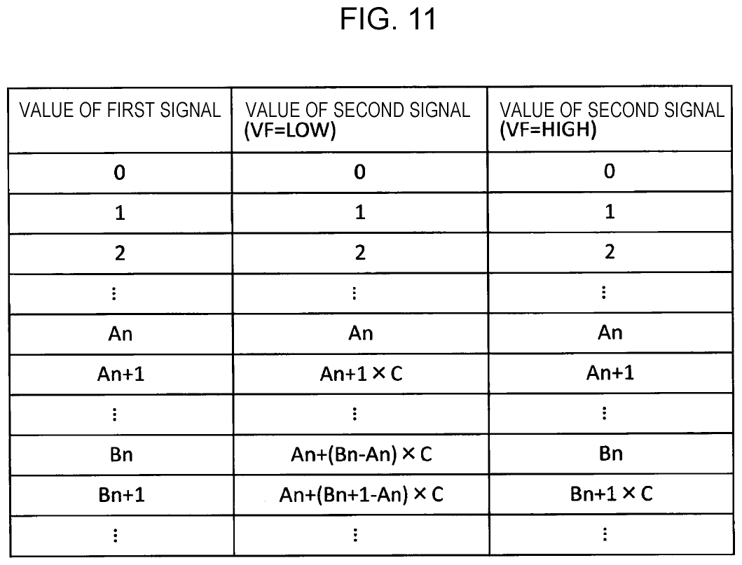

FIG. 11 is a correction table according to the second example. The left column of the correction table lists the value of the first signal of the first pixel with VF=LOW and VF=HIGH. The middle column is the value of the second signal of the first pixel with VF=LOW. The right column lists the value of the second signal of the first pixel with VF=HIGH.

The correction table in FIG. 11 associates the value of the first signal of the first pixel with the value of the second signal of the first pixel with VF=LOW. The correction table also associates the value of the first signal of the first pixel with the value of the second signal of the first pixel with VF=HIGH.

With VF=LOW, in the region where the value of the first signal of the first pixel is equal to or above 0 and equal to or below An, the value of the first signal of the first pixel is equal to the value of the second signal of the first pixel. In the region where the value of the first signal of the first pixel is above An, the value of the second signal of the first pixel is (An+(X−An)×C) if the value of the first signal of the first pixel is X. It is noted that C is a correction factor. As illustrated in FIG. 11, the description with “VF=LOW” and “An” respectively interchanged with “VF=HIGH” and “Bn” also holds true.

In the second example as illustrated in FIG. 10, the light exposure to first signal level characteristics are different depending on whether the control potential VF to be applied to a pixel is higher or lower. Specifically, the threshold light exposure is different depending on the control potential VF. According to the correction of the correction table in FIG. 11, the light exposure to second signal level characteristics may be aligned in these cases. The linearity of the light exposure to second signal level characteristics at each control potential VF may be ensured.

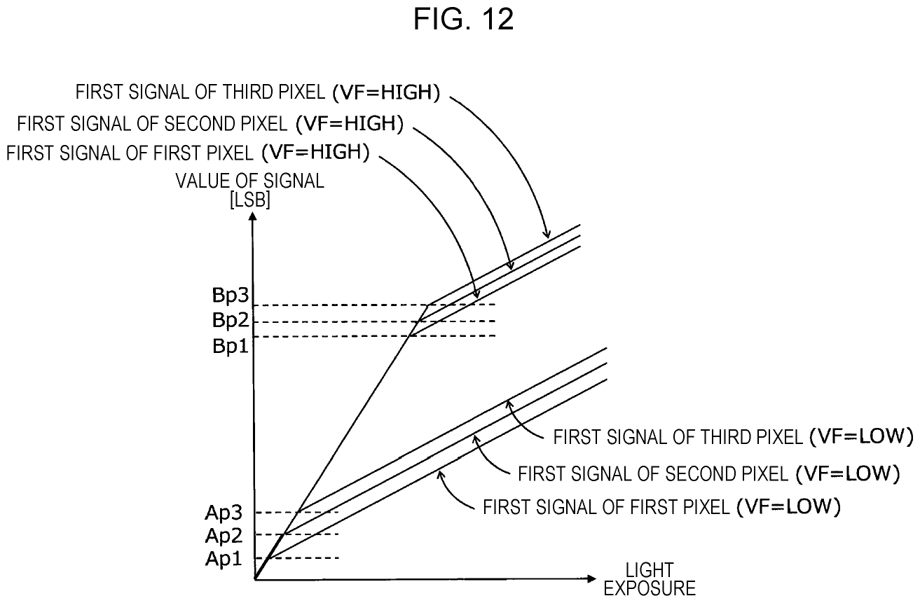

FIG. 12 is a graph related to a third example and illustrating the light exposure to first signal level characteristics of each pixel at each control potential VF. Six graph lines of the third example are related to three pixels 11a. The three pixels 11a include a first pixel, a second pixel, and a third pixel.

Referring to FIG. 12, if each of the first, the second and the third pixels has a lower control potential VF, the light exposure is lower. If each of the first, the second and the third pixels has a higher control potential VF, the light exposure is higher.

FIG. 12 illustrates variations in the threshold voltages of the first transistors 81 of the first, the second and third pixels. The variation in the threshold voltage leads to a variation in the threshold light exposure of the light exposure to first signal level characteristics.

Referring to FIG. 12, Ap1 on the ordinate is the value of the first signal responsive to the threshold light exposure in the light exposure to first signal level characteristics of the first pixel with VF=LOW. Bp1 on the ordinate is the value of the first signal responsive to the threshold light exposure in the light exposure to first signal level characteristics of the first pixel with VF=HIGH. Ap2 on the ordinate is the value of the first signal responsive to the threshold light exposure in the light exposure to first signal level characteristics of the second pixel with VF=LOW. Bp2 on the ordinate is the value of the first signal responsive to the threshold light exposure in the light exposure to first signal level characteristics of the second pixel with VF=HIGH. Ap3 on the ordinate is the value of the first signal responsive to the threshold light exposure in the gamma characteristics of the third pixel with VF=LOW. Bp3 on the ordinate is the value of the first signal responsive to the threshold light exposure in the gamma characteristics of the third pixel with VF=HIGH.

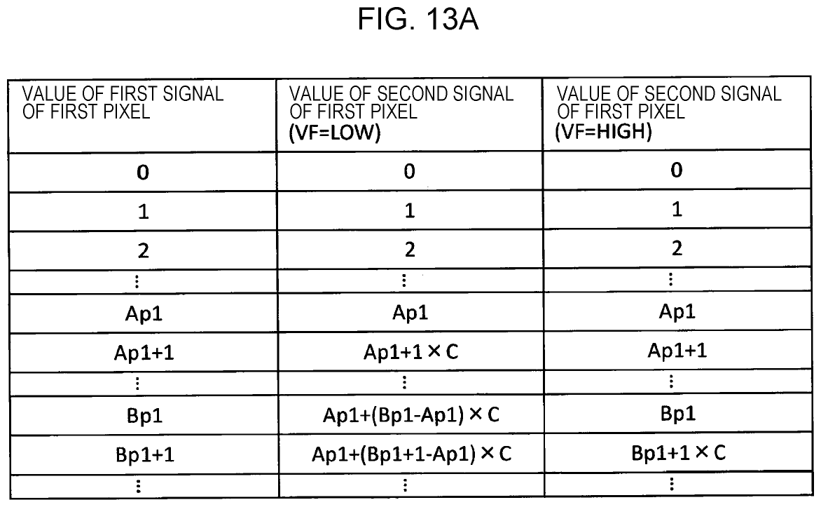

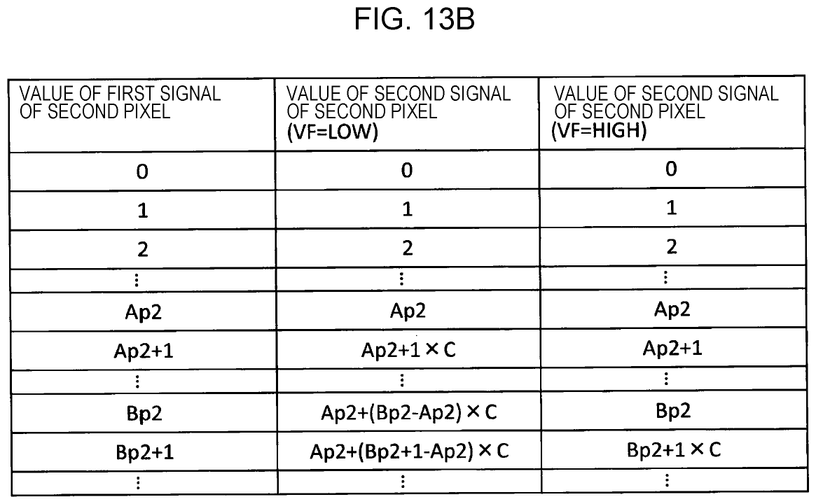

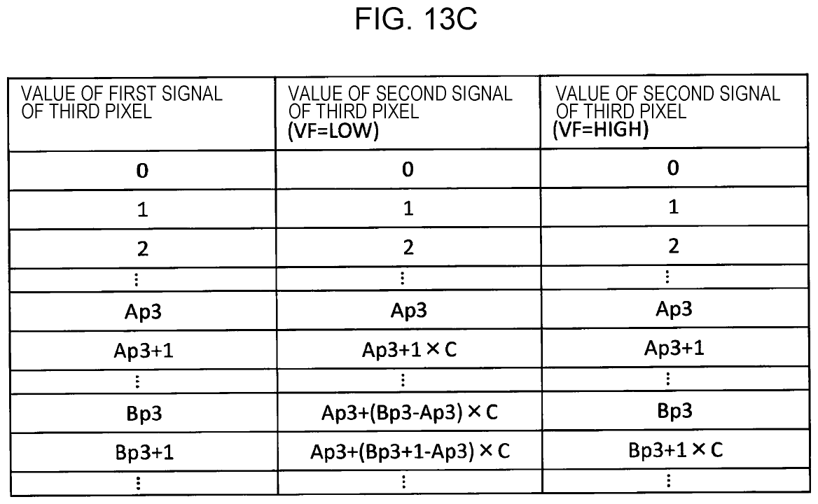

FIG. 13A is a correction table of the signal of the first pixel according to the third example. The left column of the correction table lists the value of the first signal of the first pixel with VF=LOW and VF=HIGH. The middle column lists the value of the second signal of the first pixel with VF=LOW. The right column lists the value of the second signal of the first pixel with VF=HIGH.

The correction table in FIG. 13A associates the value of the first signal of the first pixel with the value of the second signal of the first pixel with VF=LOW. The correction table also associates the value of the first signal of the first pixel with the value of the second signal of the first pixel with VF=HIGH.

With VF=LOW, the value of the first signal of the first pixel is equal to the value of the second signal of the first pixel in the region where the value of the first signal of the first pixel is equal to or above 0 and equal to or below Ap1. In the region where the value of the first signal of the first pixel is above Ap1, the value of the second signal of the first pixel is (Ap1+(X−Ap1)×C) if the value of the first signal of the first pixel is X. It is noted that C is a correction factor. As illustrated in FIG. 13A, the description with “VF=LOW” and “Ap1” respectively interchanged with “VF=HIGH” and “Bp1” also holds true.

FIG. 13B is a correction table of the signal of the second pixel according to the third example. The description of the correction table in FIG. 13B is equivalent to the description of the correction table of FIG. 13A with the “first pixel,” “Ap1,” and “Bp1” respectively interchanged with the “second pixel,” “Ap2,” and “Bp2.”

FIG. 13C is a correction table of the signal of the third pixel according to the third example. The description of the correction table in FIG. 13C is equivalent to the description of the correction table in FIG. 13A with the “first pixel,” “Ap1,” and “Bp1” respectively interchanged with the “third pixel,” “Ap3,” and “Bp3.”

For convenience of explanation, FIGS. 13A through 13C illustrate the correction tables respectively for the first, second and third pixels. The correction tables may be separately formed respectively for the first, second and third pixels or a unified correction table may be formed for the first, second and third pixels.

According to the third example as illustrated in FIG. 12, the light exposure to first signal level characteristics are different depending on whether the control potential VF is higher or lower in each pixel. The light exposure to first signal level characteristics of the pixels are also different when the control potentials VF are equal. Specifically, a difference between the value Ap1 and the value Ap2 is larger than a difference between the value Bp1 and the value Bp2. A difference between the value Ap2 and the value Ap3 is larger than a difference between the value Bp2 and the value Bp3. A difference between the value Ap3 and the value Ap1 is larger than a difference between the value Bp3 and the value Bp1. The correction in accordance with the correction tables in FIGS. 13A through 13C may align the light exposure to second signal level characteristics. The linearity of the light exposure to second signal level characteristics of each pixel at each control potential VF may be ensured.

Case in which Variation occurs in Capacitance Value of Charge Storage Region Z between Pixels

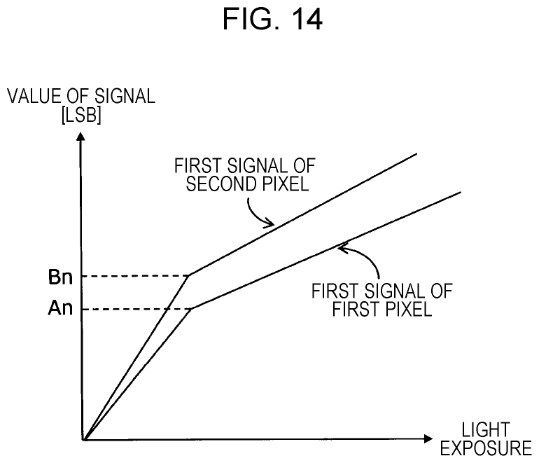

FIG. 14 illustrates a variation in the light exposure to first signal level characteristics of each pixel according to a fourth example. The two graph lines in the fourth example are related to two pixels 11a. In the following discussion, the two pixels 11a are the first pixel and the second pixel.

FIG. 14 illustrates a variation in the capacitance value of the charge storage region Z between the first pixel and the second pixel. This leads to a variation in the light exposure to first signal level characteristics. Specifically, a variation occurs in the threshold light exposure, and a variation occurs in the gradient of the lines of the light exposure to first signal level characteristics. More specifically, the gradient of the graph line in the region where the light exposure is lower than the threshold light exposure is varied from the gradient of the graph line in the region where the light exposure is higher than the threshold light exposure. The capacitance value of the charge storage region Z herein refers to a capacitance value in the state that the first capacitive element 71 in the capacitance circuit CC is not active with the first transistor 81 turned off.

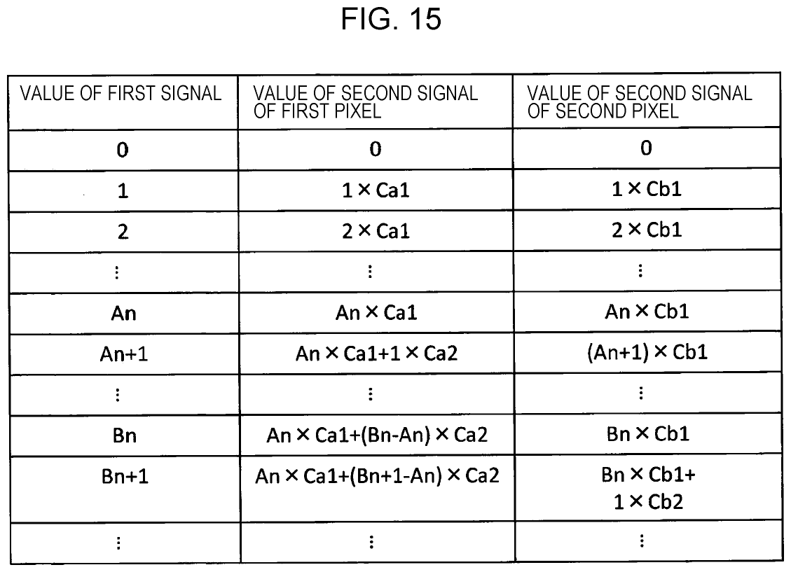

FIG. 15 is a correction table according to the fourth example. The left column of the correction table lists the values of the first signals of the first pixel and the second pixel. The middle column lists the value of the second signal of the first pixel. The right column lists the value of the second signal of the second pixel. The correction table associates the value of the first signal of the first pixel with the value of the second signal of the first pixel. The correction table also associates the value of the first signal of the second pixel with the value of the second signal of the second pixel.

In the region where the value of the first signal of the second pixel is equal to or above 0 and equal to or below An, the value of the second signal of the first pixel is (X×Ca1) when the value of the second signal of the first pixel is X. In the region where the value of the first signal of the first pixel is above An, the value of the second signal of the first pixel is (An×Ca1+(X−An)×Ca2) when the value of the first signal of the first pixel is X. It is noted that Ca1 and Ca2 are correction factors. As illustrated in FIG. 15, the description with the “first pixel,” “An,” “Ca1,” and “Ca2” respectively interchanged with the “second pixel,” “Bn,” “Cb1,” and “Cb2” also holds true.

In the fourth example as illustrated in FIG. 14, the variation occurs in each pixel in the threshold light exposure, and the gradient of the graph line in the region where the light exposure is below the threshold light exposure is varied from the gradient of the graph line in the region where the light exposure is above the threshold light exposure. The correction in accordance with the correction table in FIG. 15 may align the light exposure to second signal level characteristics. The linearity of the light exposure to second signal level characteristics of each pixel may be ensured.

Case in which Variation occurs in Element Characteristics of Capacitance Circuit between Pixels and Linearity of First Signal with respect to Light Exposure to Pixel 11a is lower

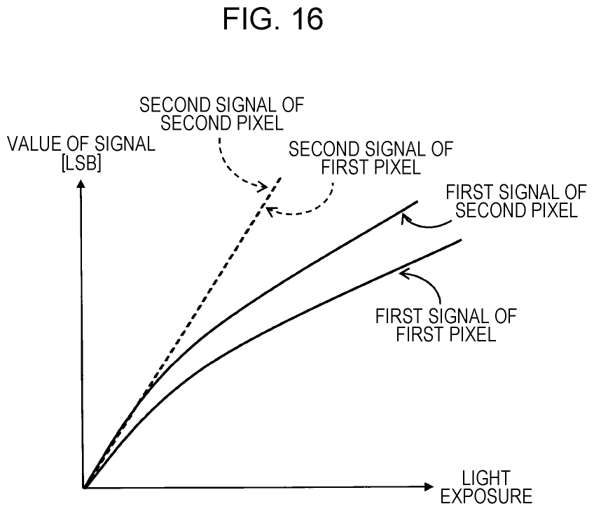

FIG. 16 is a graph illustrating a variation in the light exposure to first signal level characteristics of each pixel according to a fifth example. The two graph lines in the fifth example are related to two pixels 11a. The two pixels 11a includes the first pixel and the second pixel.

Referring to FIG. 16, variations occur in the light exposure to first signal level characteristics between the first pixel and the second pixel and the linearity of the light exposure to first signal level characteristics is relatively low. Specifically, in the fifth example, when the source-drain voltage of the first transistor 81 varies across the threshold voltage, the capacitance value of the charge storage region Z gradually varies in the vicinity of the threshold voltage instead of varying in a stepwise fashion. This leads to a lower linearity of the light exposure to first signal level characteristics of the fifth example.

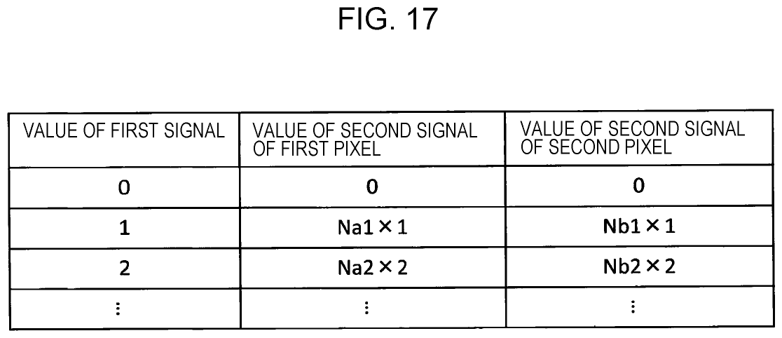

FIG. 17 is a correction table according to the fifth example. The left column of the correction table lists the values of the first signals of the first pixel and the second pixel. The middle column lists the value of the second signal of the first pixel. The right column lists the value of the second signal of the second pixel. The correction table associates the value of the first signal of the first pixel with the value of the second signal of the first pixel. The correction table also associates the value of the first signal of the second pixel with the value of the second signal of the second pixel.

The value of the second signal of the first pixel is obtained by multiplying the value of the first signal of the first pixel by a correction factor. The correction factor is set on each value of the first signal of the first pixel. Referring to FIG. 17, Na1, Na2, . . . are correction factors that are used to correct the values of the first signals of the first pixels to the values of the second signals of the first pixels.

The value of the second signal of the second pixel is obtained by multiplying the value of the first signal of the second pixel by a correction factor. The correction factor is set on each value of the first signal of the second pixel. Referring to FIG. 17, Nb1, Nb2, are correction factors that are used to correct the values of the first signals of the second pixels to the values of the second signals of the second pixels.

In the fifth example as illustrated in FIG. 16, the graph lines of the light exposure to first signal level characteristics of each pixel are curved and varied from pixel to pixel. The correction in accordance with the correction table in FIG. 17 may align the light exposure to second signal level characteristics. The linearity of the light exposure to second signal level characteristics of each pixel may be ensured.

Other embodiments of the disclosure are described below. In the following discussion, elements common to the first embodiment and examples described above, and common to embodiments and examples to be described as below are designed with the same reference numerals and the discussion thereof may not be repeated. The discussion about one embodiment and one example may be mutually applicable as the discussion about another embodiment and another example as long as they are mutually consistent. For example, the correction circuit 504 described above may be employed in the embodiments and examples described below.

### SECOND EMBODIMENT

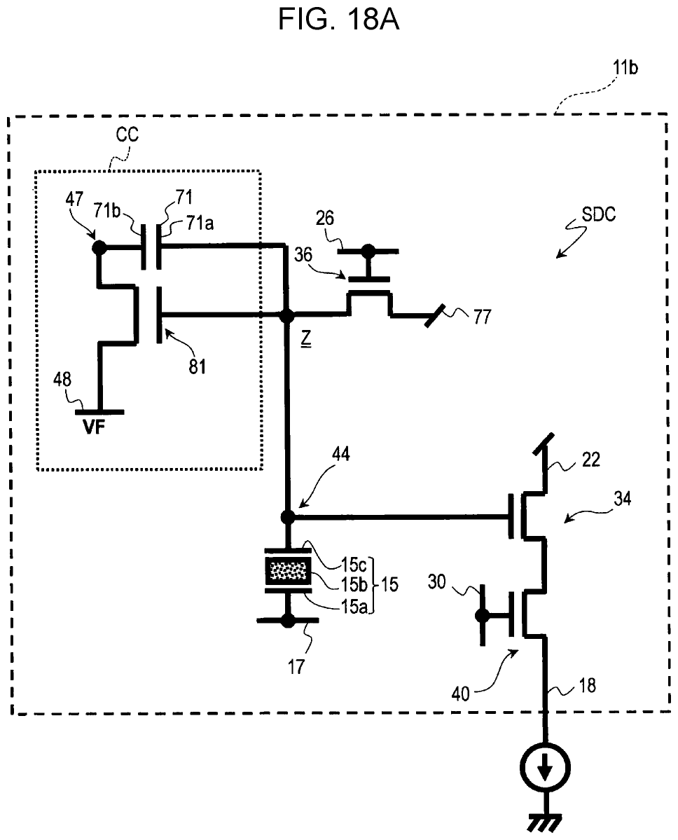

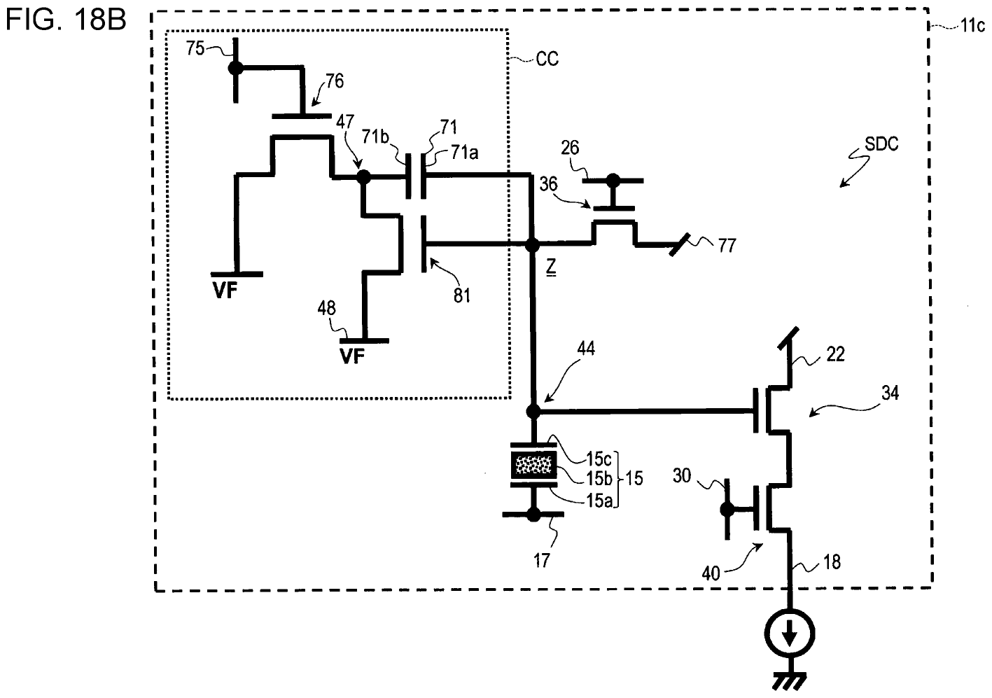

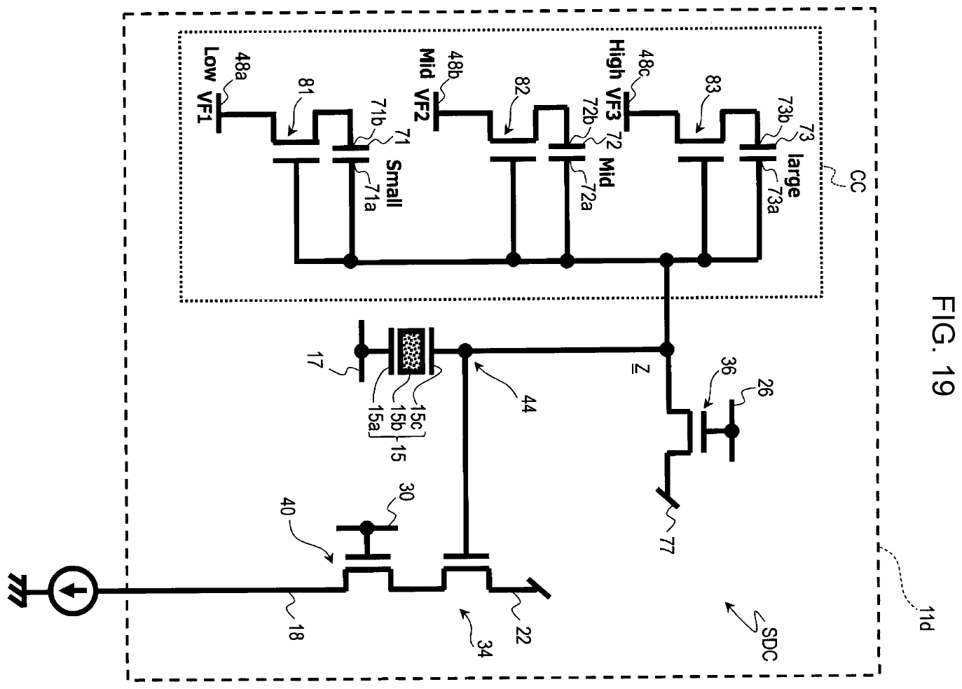

FIG. 18A is an exemplary schematic circuit diagram of a pixel 11b of a second embodiment. A difference between the circuit configuration of the pixel 11b of the second embodiment in FIG. 18A and the circuit configuration of the pixel 11a of the first embodiment in FIG. 2 lies in the capacitance circuit CC.

In the second embodiment, the first voltage supply circuit 48, the first transistor 81, the first capacitive element 71, and the charge storage region Z are connected in series in this order.

In the second embodiment, the first gate of the first transistor 81 is connected to the first terminal 71a of the first capacitive element 71 and the charge storage region Z. One of the first source and the first drain of the first transistor 81 is connected to the second terminal 71b of the first capacitive element 71. The other of the first source and the first drain of the first transistor 81 is supplied with the control potential VF from the first voltage supply circuit 48.

In the second embodiment, the node 47 is connected to the one of the first source and the first drain of the first transistor 81 and the second terminal 71b of the first capacitive element 71. The first voltage supply circuit 48 is connected to the other of the first source and the first drain of the first transistor 81.

When the potential of the first gate of the first transistor 81 is lower, the first transistor 81 is turned off. The second terminal 71b is not supplied with the control potential VF. The second terminal 71b remains floating. In such a case, the first capacitive element 71 is not active as a capacitance. Specifically, the first capacitive element 71 does not function as a capacitance of the charge storage region Z.

During light exposure, the potential of the first gate of the first transistor 81 rises. While the potential of the first gate rises, the gate-source voltage of the first transistor 81 exceeds the threshold voltage, turning on the first transistor 81. When the first transistor 81 is turned on, the control potential VF is applied to the second terminal 71b via the first source and the first drain of the first transistor 81. The potential of the second terminal 71b is thus fixed. In this way, the first capacitive element 71 turns active as a capacitance. Specifically, the first capacitive element 71 functions as a capacitance of the charge storage region Z. The capacitance value of the charge storage region Z thus increases. Specifically, the capacitance value of the first capacitive element 71 is added as a capacitance of the charge storage region Z.

Referring to FIG. 18A, the potential of the node 47 may be reset by applying the control potential VF via the first transistor 81.

FIG. 18B is the exemplary schematic circuit diagram of a pixel 11c of another example of the second embodiment. Referring to FIG. 18B, the node 47 connects to one of the source and the drain of the specific reset transistor 76 in the pixel 11c. The other of the source and the drain of the specific reset transistor 76 is supplied with the control potential VF from the first voltage supply circuit 48.

Referring to FIG. 18B, the potential of the node 47 may be reset by turning on the specific reset transistor 76.

### THIRD EMBODIMENT

FIG. 19 is the exemplary schematic circuit diagram of a pixel 11d of a third embodiment. The capacitance circuit CC of the pixel 11d of the third embodiment in FIG. 19 includes multiple stages of the capacitance circuit CC of the second embodiment in FIG. 18A.

In the third embodiment, the capacitance circuit CC includes power supply circuits 48a, 48b, and 48c, transistors 81, 82, and 83, and capacitive elements 71, 72, and 73.

In the following discussion, the source of the second transistor 82 is also referred to as a second source. The drain of the second transistor 82 is also referred to as a second drain. The gate of the second transistor 82 is also referred to as a second gate. The source of the third transistor 83 is also referred to as a third source. The drain of the third transistor 83 is also referred to as a third drain. The gate of the third transistor 83 is also referred to as a third gate.

The capacitive element 72 includes a first terminal 72a and a second terminal 72b. The third capacitive element 73 includes a first terminal 73a and a second terminal 73b.

The first terminal 71a is connected to the charge holding node 44. One of the first source and the first drain of the first transistor 81 is connected to the second terminal 71b. The other of the first source and the first drain of the first transistor 81 is supplied with a first control potential VF1 from the first voltage supply circuit 48a.

The second gate and the first terminal 72a are connected to the charge holding node 44. One of the second source and the second drain is connected to the second terminal 72b. The other of the second source and the second drain is supplied with a second control potential VF2 from the second voltage supply circuit 48b.

The third gate and the first terminal 73a are connected to the charge holding node 44. One of the third source and the third drain is connected to the second terminal 73b. The other of the third source and the third drain is supplied with a third control potential VF3 from the third voltage supply circuit 48c.

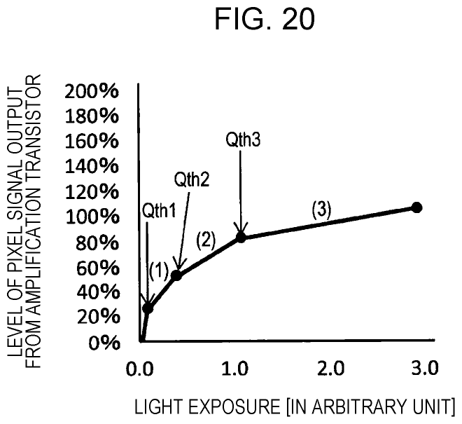

FIG. 20 is a graph illustrating the light exposure to pixel signal level characteristics in a second mode according to the third embodiment. The first capacitive element 71 turns active as a capacitance when the light exposure to the pixel 11d increases across a first threshold light exposure Qth1. The capacitance value of the charge storage region Z increases. When the light exposure increases across the second threshold light exposure Qth2, the second capacitive element 72 turns active as a capacitance. In this way, the capacitance value of the charge storage region Z increases. When the light exposure increases across a third threshold light exposure Qth3, the third capacitive element 73 turns active as a capacitance. The capacitance value of the charge storage region Z increases.

The region where the light exposure is equal to or above the first threshold light exposure Qth1 and below the second threshold light exposure Qth2 is referred to as a region (1) in the light exposure to pixel signal level characteristics in FIG. 20. The region where the light exposure is equal to or above the second threshold light exposure Qth2 and below the third threshold light exposure Qth3 is referred to as a region (2). The region where the light exposure is equal to or above the third threshold light exposure Qth3 is referred to as a region (3).

The potential of the charge storage region Z with the light exposure at the first threshold light exposure Qth1 is referred to as a first threshold potential. The potential of the charge storage region Z with the light exposure at the second threshold light exposure Qth2 is referred to as a second threshold potential. The potential of the charge storage region Z with the light exposure at the third threshold light exposure Qth3 is referred to as a third threshold potential.

According to the third embodiment, the third control potential VF3, the second control potential VF2, and the first control potential VF1 are different from each other. In this way, the first threshold light exposure Qth1, the second threshold light exposure Qth2, and the third threshold light exposure Qth3 are different from each other.

Specifically, in the third embodiment, the third control potential VF3 is higher than the second control potential VF2. The second control potential VF2 is higher than the first control potential VF1. In this way, as illustrated in FIG. 20, the third threshold light exposure Qth3 may be set to be higher and the second threshold light exposure Qth2 may be set to be higher than the first threshold light exposure Qth1.

In the third embodiment, the capacitance value C3 of the third capacitive element 73 is higher than the capacitance value C2 of the second capacitive element 72. The capacitance value C2 of the second capacitive element 72 is higher than the capacitance value C1 of the first capacitive element 71.

In the third embodiment, the capacitance circuit CC varies the capacitance value of the charge storage region Z when the potential of the charge storage region Z varies across the first threshold light exposure. Specifically, the capacitance circuit CC varies the capacitance value of the charge storage region Z in response to the capacitance value of the first capacitive element 71. More specifically, the capacitance circuit CC increases the capacitance value of the charge storage region Z by the capacitance value of the first capacitive element 71. The description with the “first threshold potential” and the “first capacitive element 71” respectively interchanged with the “second threshold potential” and the “second capacitive element 72” also holds true. The description with the “first threshold potential” and the “capacitive element 71” respectively interchanged with the “third threshold potential” and the “third capacitive element 73” also holds true.

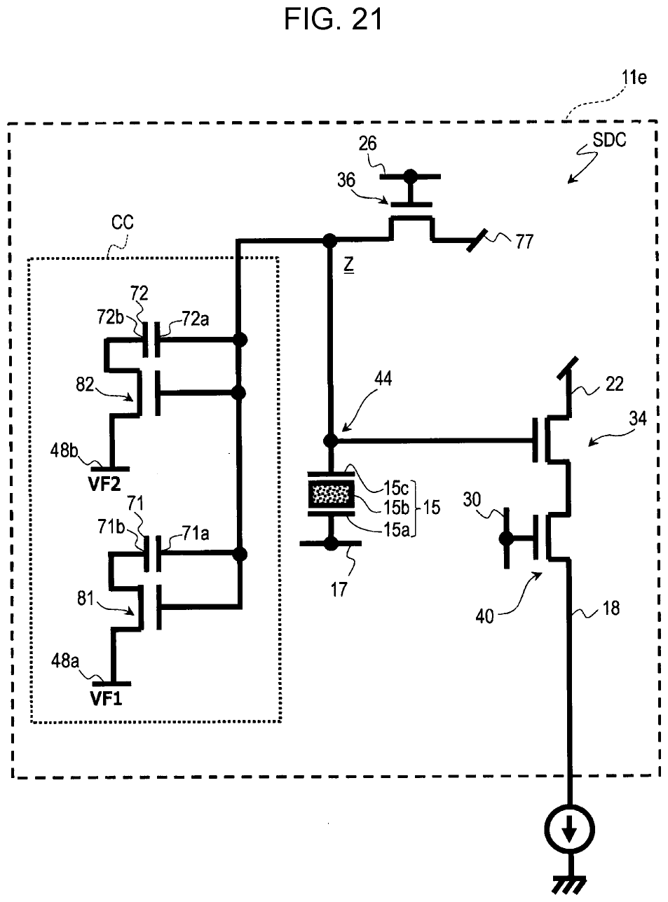

The capacitance circuit CC of the third embodiment in FIG. 19 has multiple stages of the capacitance circuit CC of the second embodiment in FIG. 18A. The capacitance circuit CC may include multiple stages of the capacitance circuit CC of another embodiment. In the third embodiment, the number of stages is three. Alternatively, the number of stages may be two or four or more. FIG. 21 is the exemplary schematic circuit diagram of a pixel 11e according to another example of the third embodiment. The pixel 11e of this example has two stages.

### Signal Processing

Case in which Variation occurs in Element Characteristics of Capacitance Circuit between Pixels

Specific example of a signal correction in the third embodiment in FIG. 21 is described below. The circuit block diagram of the signal processing in the third embodiment is identical to the circuit block diagram of the first embodiment in FIG. 6 and the discussion thereof is omitted herein.

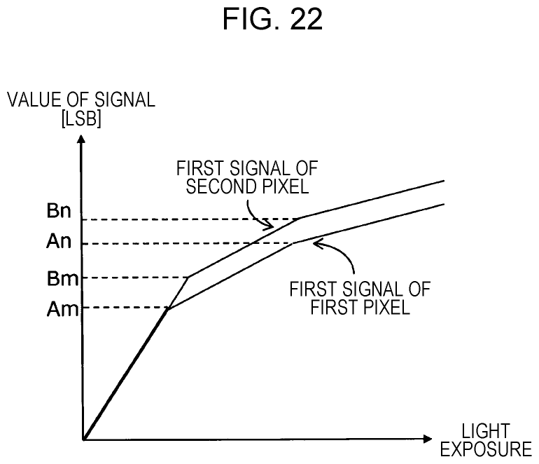

FIG. 22 is a graph illustrating variations in the light exposure to first signal level characteristics of each pixel according to a sixth example. The two graph lines in the sixth example are related to two pixels 11a. The two pixels 11a are hereinafter referred to as the first pixel and the second pixel.

FIG. 22 illustrates a variation in a first threshold voltage of the first transistor 81 between the first pixel and the second pixel and a variation in a second threshold voltage of the second transistor 82 between the first pixel and the second pixel. The variation in the first threshold voltage leads to a variation in a first threshold light exposure of the light exposure to first signal level characteristics. The variation in the second threshold voltage leads to a second threshold light exposure of the light exposure to first signal level characteristics.

Referring to FIG. 22, Am on the ordinate is a value of the first signal corresponding to the first threshold light exposure in the light exposure to first signal level characteristics of the first pixel. An on the ordinate is a value of the first signal corresponding to the second threshold light exposure in the light exposure to first signal level characteristics of the first pixel.

Referring to FIG. 22, Bm on the ordinate is a value of the first signal corresponding to the first threshold light exposure in the light exposure to first signal level characteristics of the second pixel. Bn on the ordinate is a value of the first signal corresponding to the second threshold light exposure in the light exposure to first signal level characteristics of the second pixel.

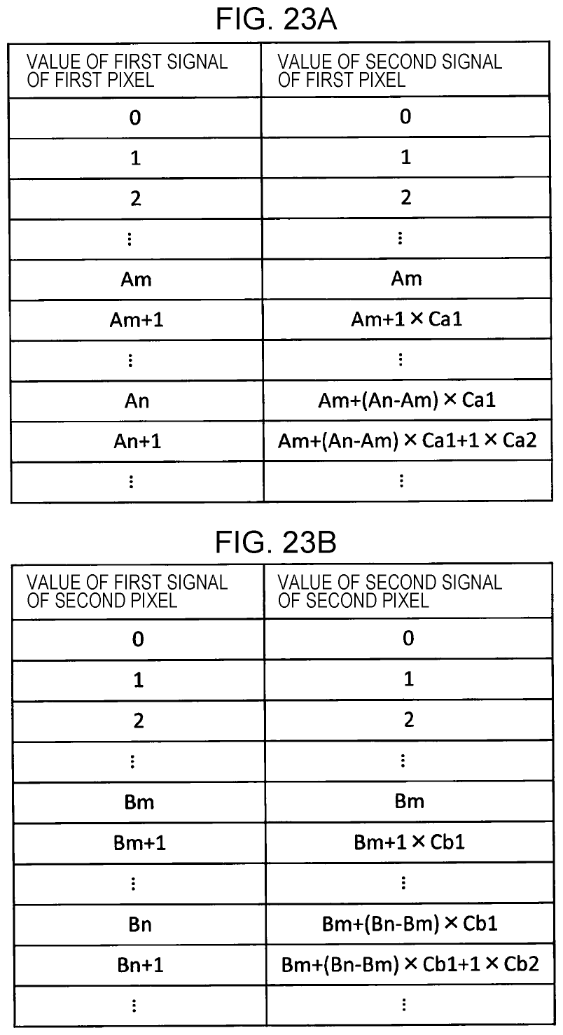

FIG. 23A is a correction table of a signal of the first pixel according to the sixth example. The left column of the correction table lists a value of the first signal of the first pixel. The right column lists a value of the second signal of the first pixel. The correction table associates the value of the first signal of the first pixel with the value of the second signal of the first pixel.

The value of the first signal of the first pixel is equal to the value of the second signal of the first pixel in the region where the value of the first signal of the first pixel is equal to or above 0 and equal to or below Am. In the region where the value of the first signal of the first pixel is above Am and equal to or below An, the value of the second signal of the first pixel is (Am+(X−Am)×Ca1) when the value of the first signal of the first pixel is X. In the region where the value of the first signal of the first pixel is above An, the value of the second signal of the first pixel is (Am+(An−Am)×Ca1+(X−An)×Ca2) when the value of the first signal of the first pixel is X. It is noted that Ca1 and Ca2 are correction factors.

FIG. 23B is a correction table of a signal of the second pixel according to the sixth example. The description of the correction table in FIG. 23B is identical to the description of the correction table in FIG. 23A with the “first pixel,” “Am,” “An,” “Ca1,” and “Ca2” respectively interchanged with the “second pixel,” “Bm,” “Bn,” “Cb1,” and “Cb2.”

For convenience of explanation, FIG. 23A and FIG. 23B illustrate the correction tables respectively for the first and second pixels. The correction tables may be separately formed respectively for the first and second pixels or a unified correction table may be formed for the first and second pixels.

In the sixth example as illustrated in FIG. 22, the light exposure to first signal level characteristics of each pixel have two threshold light exposures. The gradients of the graph lines in the light exposure to first signal level characteristics vary at each threshold light exposure. A variation occurs in the threshold light exposure from pixel to pixel. The correction in accordance with the correction tables in FIGS. 23A and 23B may align the light exposure to second signal level characteristics. The linearity of the light exposure to second signal level characteristics of each pixel at each control potential VF may thus be ensured.

Case in which Control Potential VF is varied in Three Steps

In the embodiments described above, the control potential VF applied to a pixel may be varied in three or more steps. The control potential VF is varied in three steps as described below.

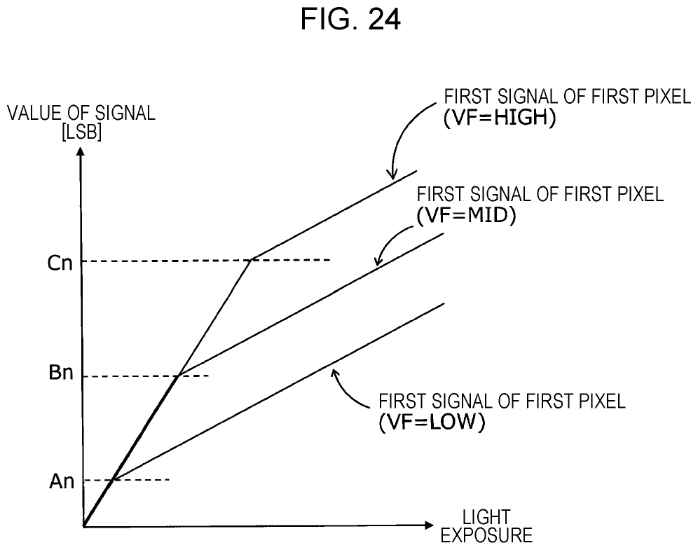

FIG. 24 is a graph illustrating variations in the light exposure to first signal level characteristics at each control potential according to a seventh example. The two graph lines in the seventh example are related to a single pixel 11a. In the following discussion, the pixel 11a is referred to as the first pixel.

Referring to FIG. 24, “VF=LOW” indicates that the control potential VF applied to the first pixel is relatively low. “VF=HIGH” indicates that the control potential VF applied to the first pixel is relatively high. “VF=MID” indicates that the control potential VF applied to the first pixel is higher than the case of VF=LOW but lower than the case of VF=HIGH.

Referring to FIG. 24, An on the ordinate is a value of the first signal corresponding to the threshold light exposure in the light exposure to first signal level characteristics of the first pixel with the case of VF=LOW. Bn on the ordinate is a value of the first signal corresponding to the threshold light exposure in the light exposure to first signal level characteristics with the case of VF=MID. Cn on the ordinate is a value of the first signal corresponding to the threshold light exposure in the light exposure to first signal level characteristics with the case of VF=HIGH.

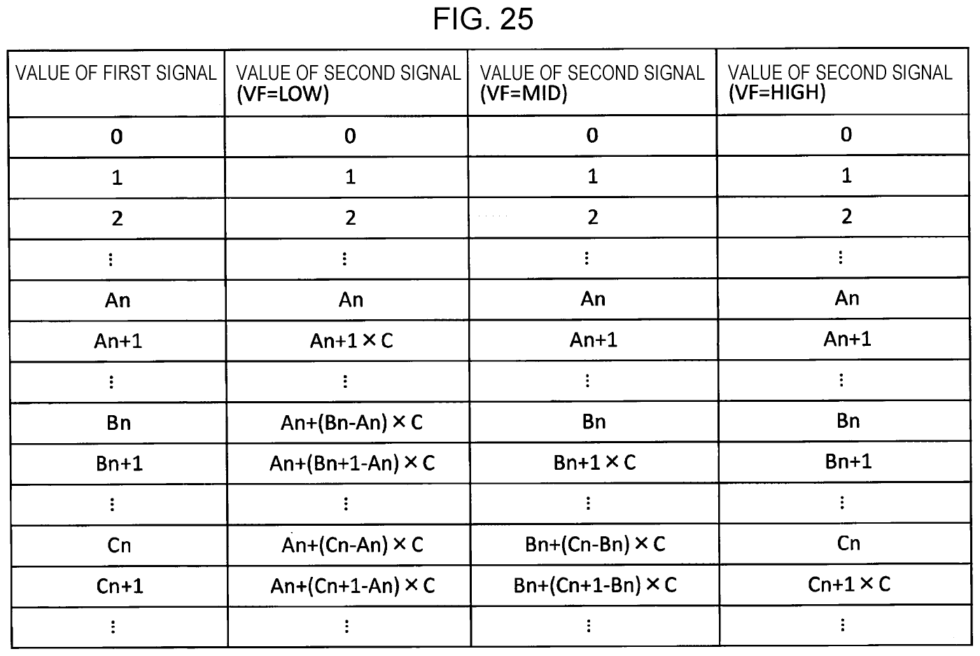

FIG. 25 is a correction table according to the seventh example. The leftmost column of the correction table lists the value of the first signal of the first pixel with the case of VF=LOW, the case of VF=MID, and the case of VF=HIGH. The second column from the left lists the value of the second signal of the first pixel with the case of VF=LOW. The third column from the left lists the value of the second signal of the first pixel with the case of VF=MID. The rightmost column lists the value of the second signal of the first pixel with the case of VF=HIGH.

The correction table in FIG. 25 associates the values of the first signal and the second signal of the first pixel with the case of VF=LOW. The correction table also associates the values of the first signal and the second signal of the first pixel with the case of VF=MID. The correction table also associates the values of the first signal and the second signal of the first pixel with the case of VF=HIGH.

The value of the first signal of the first pixel is equal to the value of the second signal of the first pixel in the region where the value of the first signal of the first pixel is equal to or above 0 and equal to or below An with the case of VF=LOW. In the region where the value of the first signal of the first pixel is above An, the value of the second signal of the first pixel is (An+(X−An)×C) when the value of the first signal of the first pixel is X. It is noted that C is a correction factor. As illustrated in FIG. 8, the description with “VF=LOW” and “An” respectively interchanged with “VF=MID” and “Bn” also holds true and the description with “VF=LOW” and “An” respectively interchanged with “VF=HIGH” and “Cn” also holds true.

In the seventh example as illustrated in FIG. 24, the light exposure to first signal level characteristics become different depending on whether the control potential VF applied to a pixel is at a lower level, at a middle level, or a higher level. The correction in accordance with the correction table in FIG. 25 may align the light exposure to second signal level characteristics. The linearity of the light exposure to second signal level characteristics at each control voltage VF may be ensured.

Case in which Gain is varied

In accordance with the embodiments described above, the signal from the pixel may be multiplied by a variable gain. Specifically, gain multiplication may be performed in analog-to-digital (AD) conversion by the AD conversion circuit 502. Alternatively, gain multiplication may be performed after the AD conversion. Correction performed by the correction circuit 504 in such gain multiplication is described below.

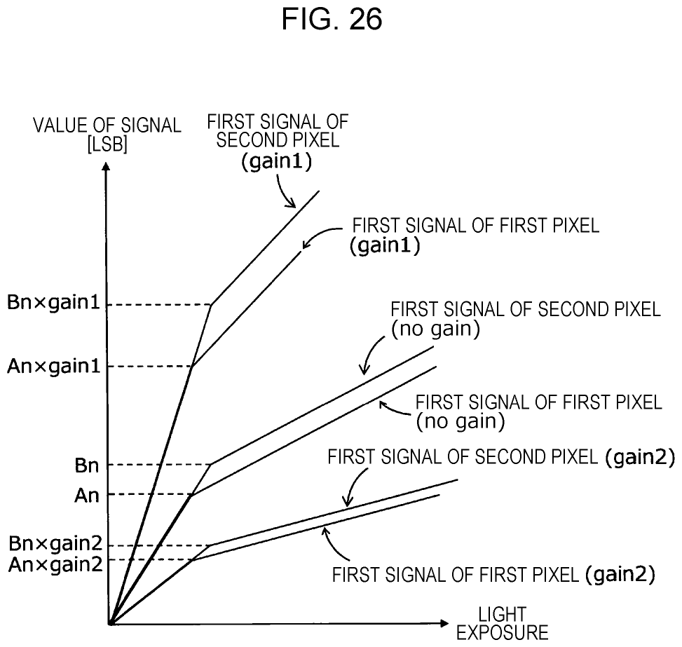

FIG. 26 illustrates a graph illustrating variations in the light exposure to first signal level characteristics of each pixel at each gain according to an eighth example. The six graph lines in the eighth example are related to two pixels 11a. The two pixels 11a includes the first pixel and the second pixel. In the following discussion, gain 1 is a plus gain, namely, a gain that higher than 1, and gain 2 is a minus gain, namely, a gain that is lower than 1. In the following discussion, not applying the gain signifies the case of gain 1.

Referring to FIG. 26, An on the ordinate is a value of the first signal corresponding to the threshold light exposure in the light exposure to first signal level characteristics of the first pixel with no gain applied. A value (An×gain 1) on the ordinate is a value of the first signal corresponding to the threshold light exposure in the light exposure to first signal level characteristics of the first pixel with gain 1 applied. A value (An×gain 2) on the ordinate is a value of the first signal corresponding to the threshold light exposure in the light exposure to first signal level characteristics of the first pixel with gain 2 applied.

Referring to FIG. 26, Bn on the ordinate is a value of the first signal corresponding to the threshold light exposure in the light exposure to first signal level characteristics of the second pixel with no gain applied. A value (Bn×gain 1) on the ordinate is a value of the first signal corresponding to the threshold light exposure in the light exposure to first signal level characteristics of the second pixel with gain 1 applied. A value (Bn×gain 2) on the ordinate is a value of the first signal corresponding to the threshold light exposure in the light exposure to first signal level characteristics of the second pixel with gain 2 applied.

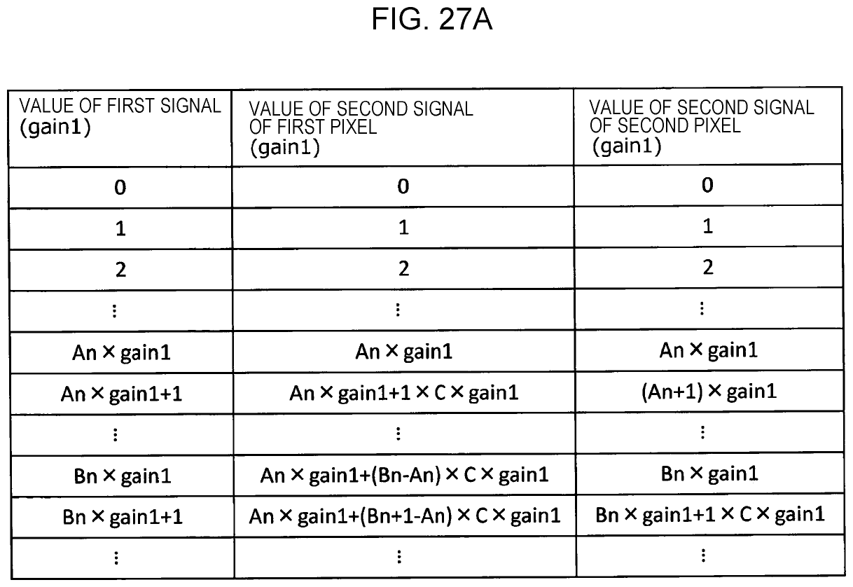

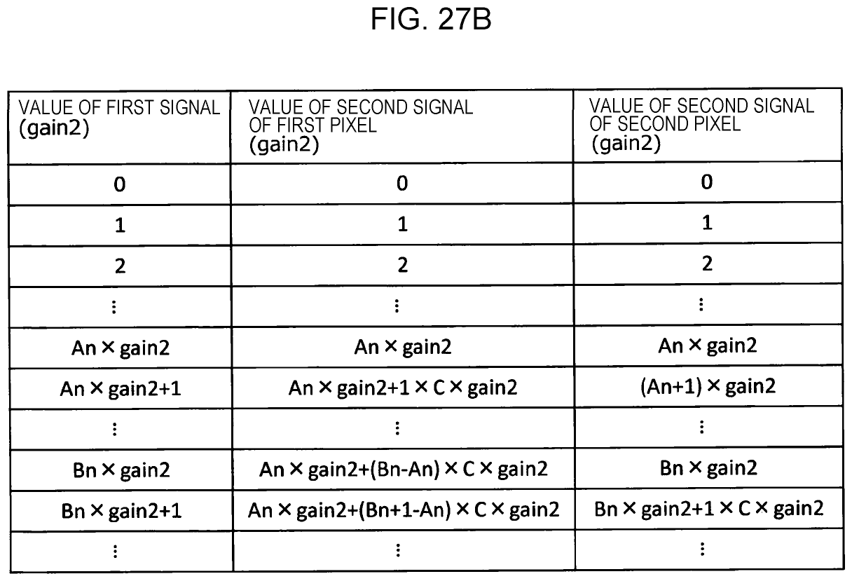

FIG. 27A is a correction table with gain 1 applied according to the eighth example. The left column of the correction table lists the values of the first signal and the second signal of the first pixel. The right column lists values of the second signals of the first pixel and the second pixel. The middle column lists the value of the second signal of the first pixel. The right column lists the value of the second signal of the second pixel. The correction table associates the value of the first signal of the first pixel with the value of the second signal of the first pixel. The correction table also associates the value of the first signal of the second pixel with the value of the second signal of the second pixel.

The value of the first signal of the first pixel is equal to the value of the second signal of the first pixel in the region where the value of the first signal of the first pixel is equal to or above 0 and equal to or below An×gain 1. In the region where the value of the first signal of the first pixel is above An×gain 1, the value of the second signal of the first pixel is (An×gain 1+(X−An)×C×gain 1) when the value of the first signal of the first pixel is X. It is noted that C is a correction factor. As illustrated in FIG. 27A, the description with the “first pixel” and “An” respectively interchanged with the “second pixel” and “Bn” also holds true.

FIG. 27B is a correction table with gain 2 according to the eighth example. The description of the correction table in FIG. 27B is identical to the description of the correction table in FIG. 27A with “gain 1” interchanged with “gain 2.”

The correction table with no gain applied according to the eighth example is identical to the correction table in FIG. 8 according to the first example.

For convenience of explanation, the correction table is different from gain to gain as illustrated in FIGS. 27A and 27B. The correction table may be formed on each gain but alternatively, a unified correction table may be formed.

In the eighth example as illustrated in FIG. 26, the light exposure to first signal level characteristics are different depending on whether a pixel signal from a pixel is applied with the plus gain, no gain, or the minus gain. Furthermore, the light exposure to first signal level characteristics are different from pixel to pixel. However, the correction in accordance with the correction tables in FIGS. 27A and 27B and the correction table identical to the correction table in FIG. 8 may align the light exposure to second signal level characteristics. The linearity of the light exposure to second signal level characteristics at each control potential VF may be ensured.

Case in which Element Characteristics of Capacitance Circuit vary in response to Temperature

In the embodiments described above, the light exposure to first signal level characteristics of the pixel may have temperature dependency. The correction performed by the correction circuit 504 in such a case is described below.

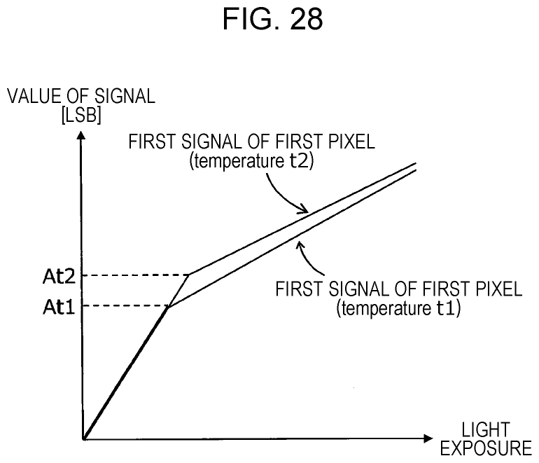

FIG. 28 is a graph illustrating variations in the light exposure to first signal level characteristics at each temperature according to a ninth example. The two graph lines according to the ninth example are related to a pixel 11a. The pixel 11a is referred to as the first pixel.

FIG. 28 illustrates a variation that occurs in the element characteristics of the capacitance circuit CC of the first pixel in response to the temperature of the capacitance circuit CC. The element characteristics varying in response to the temperature include, for example, the threshold voltage of the first transistor 81 and the capacitance value of the capacitive element 71. The variations in the light exposure to first signal level characteristics occur in response to the variation in the element characteristics. Specifically, the variation in the threshold voltage of the first transistor 81 causes a variation in the threshold light exposure. The variation in the capacitance value of the capacitive element 71 causes a variation in the gradient of the graph line of the graph of the light exposure to first signal level characteristics in the region where the light exposure is higher than the threshold light exposure.

As illustrated in FIG. 28, At1 on the ordinate is a value of the first signal corresponding to the threshold light exposure in the light exposure to first signal level characteristics of the first pixel when the capacitance circuit CC is at a first temperature t1. At2 on the ordinate is a value of the first signal corresponding to the threshold light exposure in the light exposure to first signal level characteristics of the first pixel when the capacitance circuit CC is at a second temperature t2.

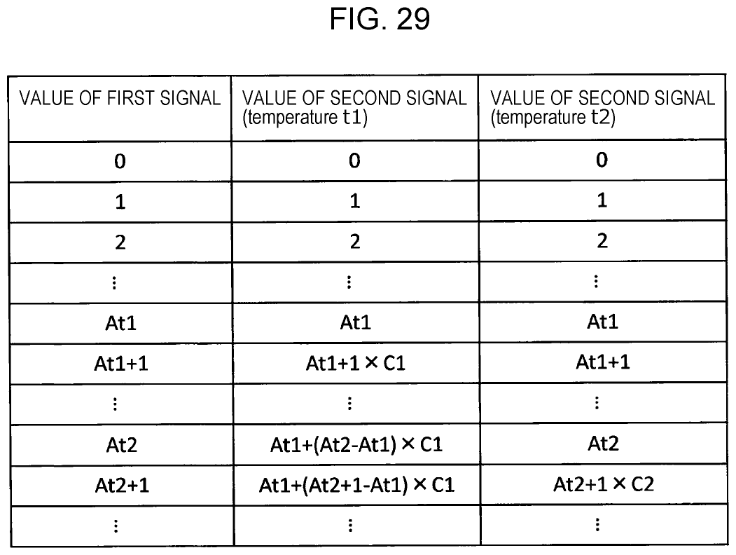

FIG. 29 is a correction table according to the ninth example. The left column of the correction table lists the value of the first signal of the first pixel when the capacitance circuit CC is at the first temperature t1 and when the capacitance circuit CC is at the second temperature t2. The middle column lists the value of the second signal of the first pixel when the capacitance circuit CC is at the first temperature t1. The right column lists the value of the second signal of the first pixel when the capacitance circuit CC is at the second temperature t2.

The correction table in FIG. 29 associates the values of the first signal and the second signal of the first pixel when the capacitance circuit CC is at the first temperature t1. The correction table also associates the values of the first signal and the second signal of the first pixel when the capacitance circuit CC is at the second temperature t2.

In the region where the value of the first signal of the first pixel is equal to or above 0 and equal to or below At1, the value of the first signal of the first pixel is equal to the value of the second signal of the first pixel when the capacitance circuit CC is at the first temperature t1. In the region where the value of the first signal of the first pixel is above At1, the value of the second signal of the first pixel is (At1+(X−At1)×C1) when the value of the first signal of the first pixel is X. It is noted that C1 is a correction factor. The description with the “first temperature t1,” “At1,” and “C1” respectively interchanged with the “second temperature t2,” “At2,” and “C2” also holds true as seen from FIG. 29.

In the ninth example in FIG. 28, the light exposure to first signal level characteristics are different depending on whether the capacitance circuit CC is lower or higher in temperature. The correction in accordance with the correction table in FIG. 29 may align the light exposure to second signal level characteristics. The linearity of the light exposure to second signal level characteristics at each control potential VF may be ensured.

### Specific Example of Configuration Related to Signal Correction

A specific example of the configuration related to the signal correction is described further below.

Specific Example of Configuration related to Correction using Correction Table

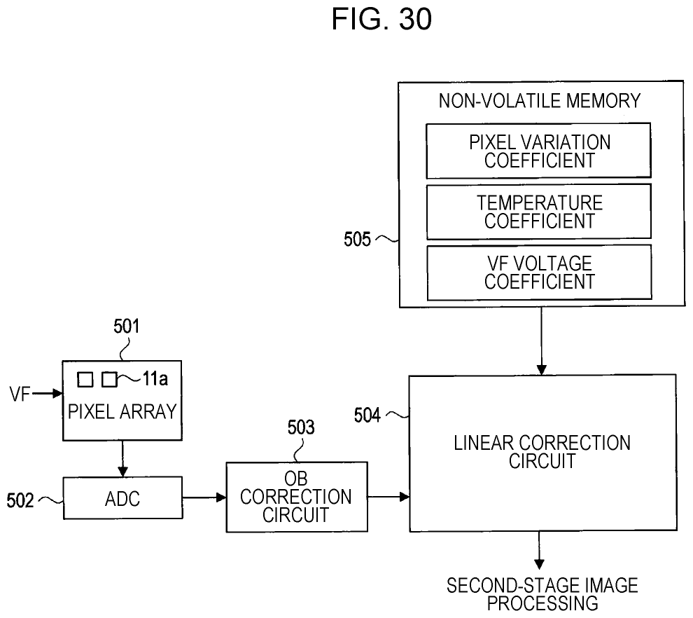

FIG. 30 is a circuit block diagram illustrating signal processing of a first specific example.

In the first specific example as in the example illustrated in FIG. 6, the non-volatile memory 505 stores the value of the first signal and the value of the second signal. In the first specific example, the correspondence relationship between the value of the first signal and the value of the second signal is responsive to a pixel variation coefficient, a temperature coefficient, and a VF coefficient.

The pixel variation coefficient is responsive to the manufacturing variation of the capacitance circuit CC from pixel to pixel. The element characteristics that are varied in response to the manufacturing variation are, for example, the threshold voltage of the first transistor 81 and the capacitance value of the first capacitive element 71.

The temperature coefficient is responsive to a variation in the temperature of the capacitance circuit CC in the element characteristics of the capacitance circuit CC. The element characteristics that are varied in response to the temperature of the capacitance circuit CC are, for example, the threshold voltage of the first transistor 81 and the capacitance value of the first capacitive element 71.

The VF coefficient is responsive to the control potential VF. The element characteristics variable in response to the control potential VF is, for example, the threshold light exposure of the light exposure to first signal level characteristics.

In the first specific example, the pixel variation coefficient, the temperature coefficient, and the VF coefficient are reflected in the correspondence relationship between the value of the first signal and the value of the second signal. In this way, the first signal and the second signal may be corrected in view of a manufacturing variation of the capacitance circuit CC from pixel to pixel, a variation in the temperature of the capacitance circuit CC in the element characteristics of the capacitance circuit CC, and a change in the element characteristics responsive to the control potential VF.

The correspondence relationship between the value of the first signal and the value of the second signal may be responsive to any one coefficient or any two coefficients selected from the group consisting of the pixel variation coefficient, the temperature coefficient, and the VF coefficient.

### Specific Example of Configuration Related to Correction Using Function

In the examples described above, the correction circuit corrects the first signal and the second signal using the correction table. The correction circuit may also correct to the second signal the first signal of at least one of the first pixel or the second pixel using a function defining a relationship between the first signal and the second signal. The correction using the function may reduce a memory capacity to be used for the correction. A specific example of the correction circuit performing the correction using the function may be described below.

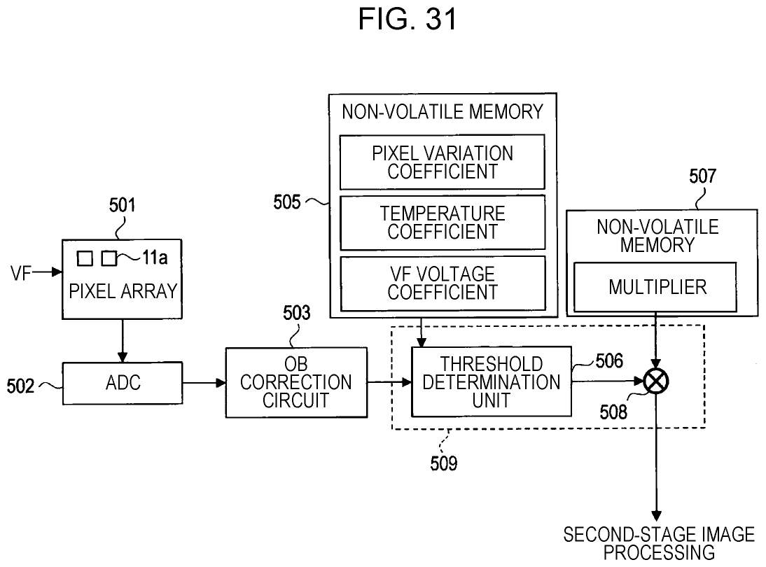

FIG. 31 is a circuit block diagram illustrating signal processing of a second specific example. The configuration in FIG. 31 includes a threshold determination unit 506, a non-volatile memory 507, and a multiplier 508.

The threshold determination unit 506 compares the value of the first signal with a signal threshold value. The signal threshold value is provided as the value of the first signal when the light exposure is the threshold light exposure. The signal threshold value may be set in response to the pixel variation coefficient, the temperature coefficient, and the VF coefficient stored on the non-volatile memory 505.

If the value of the first signal is equal to or below the signal threshold value, the multiplier 508 determines the value of the second signal by multiplying the value of the first signal by 1. If the value of the first signal is above the signal threshold value, the multiplier 508 calculates the value of the second signal by multiplying the value of the first signal by a multiplier.

In other words, if the value of the first signal is equal to or below the signal threshold value, the value of the second signal is equal to the value of the first signal. If the value of the first signal is equal to or above the signal threshold value, the value of the second signal is a value equal to a product of the value of the first signal and the multiplier.

In the second specific example, a correction circuit 509 includes the threshold determination unit 506 and the multiplier 508. In the second specific example, the correction circuit 509 uses the function to generate the second signal from the first signal. Specifically, if the value of the first signal is equal to or below the signal threshold value, the function equalizes the value of the second signal to the value of the first signal. On the other hand, if the value of the first signal is above the signal threshold value, the function equalizes the value of the second signal to the product of the value of the first signal and the multiplier.

In the example in which the function is used, there are cases when the value of the first signal as the argument of the function is equal to the value of the second signal obtained from the function. Even in such a case, the third embodiment treats the first signal as being corrected to the second signal. In other words, if the function is performed on the signal from the pixel, the first signal is treated as being corrected to the second signal via the function.

Setting of Correspondence Relationship between First Signal and Second Signal

The correspondence relationship between the first signal and the second signal may be set in advance to correct the first signal to the second signal. For example, a first data set representing the correspondence relationship between the light exposure and the first signal is obtained in advance through experiments. A second data set representing the correspondence relationship between the light exposure and the second signal is generated in accordance with the first data set.

When the correction is performed using the correction table, the value of the first signal of the first data set and the value of the second signal of the second data set may be stored in an associated form at each light exposure in a table format as illustrated in FIG. 8. The left column of the correction table in FIG. 8 lists the value of the first signal of the first data set. The middle column and the left column list the value of the second signal of the second data set.

When the correction is performed using the function, the function may be an approximate function obtained described below. The approximate function that determines the value of the second signal from the value of the first signal may be obtained in accordance with two-valued-variable data of the values of the first signal and the second signal acquired through a preliminary experiment. A related-art technique, such as the least-square method, may be used to determine the approximate function. The approximate function may be a combination of multiple linear functions. In a specific example, the first signal is corrected to the second signal in accordance with a first linear function if the value of the first signal falls within a first range or the first signal is corrected to the second signal in accordance with a second linear function if the value of the first signal falls within a second range.

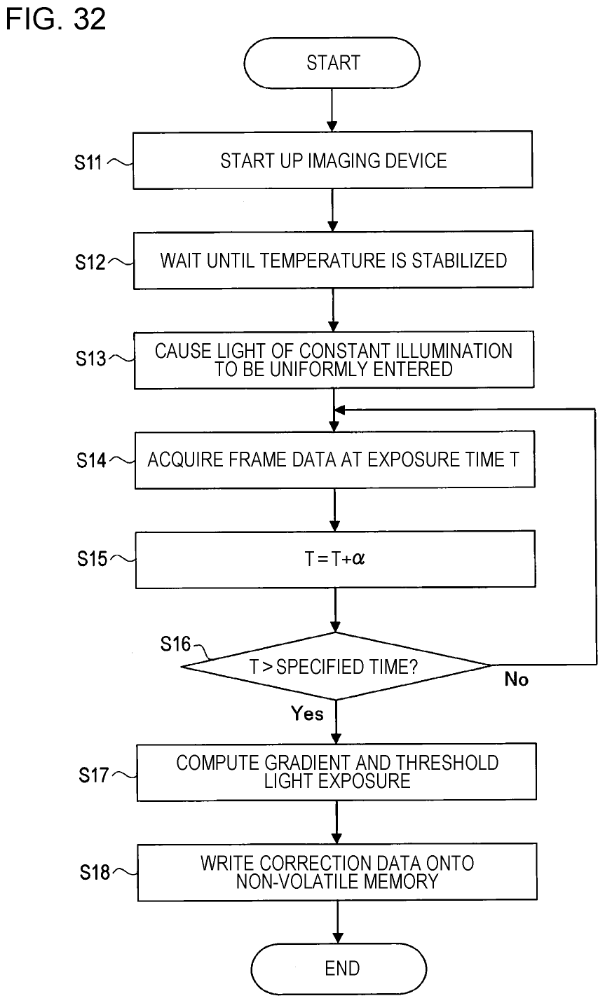

A specific example to acquire correction data used to correct the first signal to the second signal is described with reference to FIGS. 32 through 34. The specific example is used to generate the correction table. The technique related to the following specific example may be also applicable to the generation of the function for the correction. Correction Data Acquisition Flow of First Acquisition Example in which Light Exposure is changed

FIG. 32 is a flowchart illustrating a first acquisition example. In the first acquisition example, the correction data to correct the first signal to the second signal is acquired under the following condition:
Temperature of the capacitance circuit CC is constant;
Control potential VF is constant; and
Light exposure is changed by changing exposure time under condition of constant illumination.

In step S11, the imaging device 101 is started up. In step S12, the imaging device 101 waits on standby until the temperature of the capacitance circuit CC is stabilized. In step S13, light of a constant illumination is uniformly incident on the photoelectric converter 15 in the imaging device 101.

In step S14, frame data is acquired at exposure time T. The frame data acquired in step S14 in each cycle is a data pair of the value of the light exposure and the value of the first signal and forms the data pair belonging to the first data set. In step S14 at a first cycle, the exposure time T is an initial value. In the following discussion, the value of the exposure time T is also simply referred to as “T.”

In step S14, the frame data is acquired N times at the exposure time T. The average of the frame data acquired N times is calculated. The average value acquired in step S14 is treated as the frame data. In this way, the frame data is free from the influence of light shot noise or the like, and the frame data acquired in step S14 may thus be stabilized.

In step S15, T is updated to T=T+α. In other words, T is increased by a in step S15.

In step S16, the imaging device 101 determines whether the exposure time T is longer than specified time. If the exposure time T is longer than the specified time, processing proceeds to step S17. If the exposure time T is equal to or shorter than the specified time, processing returns to step S14.

Before proceeding to step S17, the light exposure is modified from the light exposure with the exposure time T being the initial value to the light exposure with the exposure time T being the specified time. In step S17, the first data set is obtained having the value of the light exposure paired with the value of the first signal present at each light exposure. The light exposure to first signal level characteristics indicated by the first data set have gamma characteristics.

In step S17, the threshold light exposure of the light exposure to first signal level characteristics is calculated. A first gradient and a second gradient in the graph lines of the light exposure to first signal level characteristics are calculated. The first gradient is in the region where the light exposure is lower than the threshold light exposure in the graph of the light exposure to first signal level characteristics. The second gradient is in the region where the light exposure is higher that the threshold light exposure in the graph of the light exposure to first signal level characteristics.

In this example herein, a linear line created herein has the first gradient and extends not only in the region where the light exposure is lower than the threshold light exposure but also in the region where the light exposure is higher than the threshold light exposure. A set of data having the value of the light exposure and the value of the signal on the linear graph is created as the second data set. The value of the first signal in the first data set and the value of the second signal in the second data set are associated with each other at each light exposure. The correction data to correct the value of the first signal to the value of the second signal is thus acquired.

In step S18, the correction data is written on the non-volatile memory 505. The non-volatile memory 505 stores the correction data in a table format.

The first acquisition example may be applied to the examples illustrated in FIGS. 7, 14, 16, 22, 26, and other figures. According to the first acquisition example, the correction tables illustrated in FIGS. 8, 15, 17, 23A, 23B, 27A, 27B, and other figures are obtained. Correction Data Acquisition Flow of Second Acquisition Example in which Light Exposure and Control Potential VF are changed

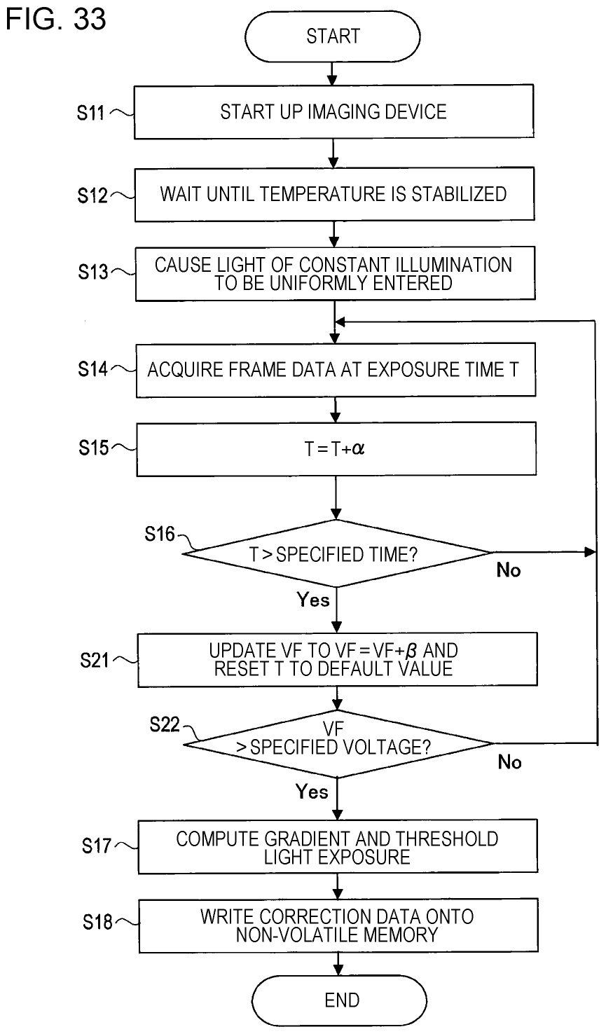

FIG. 33 is a flowchart illustrating a second acquisition example. In the second acquisition example, the correction data to correct the first signal to the second signal is acquired under the following condition: Temperature of the capacitance circuit CC is constant; Control potential VF is changed; and Light exposure is changed by changing exposure time under condition of constant illumination.

In the discussion of the second acquisition example, the value of the control potential VF is also simply referred to as VF. In this example, the initial value of VF is zero.

If the exposure time T is determined in step S16 to be longer than the specified time in the second acquisition example, processing proceeds to step S21.

In step S21, the control potential VF is updated to VF=VF+β. In other words, VF is increased by β in step S21. The exposure time T is reset to the initial value in step S21.

In step S22, the imaging device 101 determines whether the control potential VF is higher than a specified potential. If the control potential VF is above the specified potential, processing proceeds to step S17. If the control potential VF is equal to or below the specified potential, processing returns to step S14.

Before proceeding step S17, the light exposure is modified from the light exposure with the exposure time T being the initial value to the light exposure with the exposure time T being the specified time. The control potential VF is thus modified from zero to the specified potential at each light exposure. In step S17, the first data set having the value of the light exposure paired with the value of the first signal present is obtained at each light exposure and each control potential VF. The light exposure to first signal level characteristics indicated by the first data set have gamma characteristics.

In the second acquisition example, the first data set thus acquired is supplied in steps S17 and S18.

The second acquisition example may be applied to the examples illustrated in FIGS. 10, 12, 24, and other figures. According to the second acquisition example, the correction tables in FIGS. 11, 13A, 13B, 13C, 25, and other figures are obtained. Correction Data Acquisition Flow of Third Acquisition Example in which Temperature of Capacitance Circuit, Light Exposure and Control Potential VF are changed

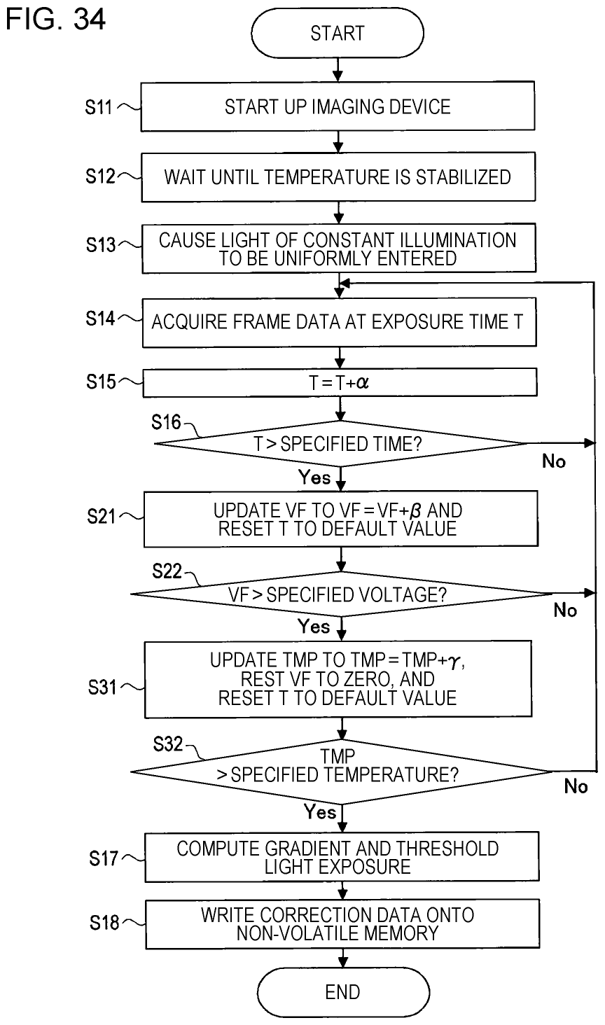

FIG. 34 is a flowchart illustrating a third acquisition example. In the third acquisition example, the correction data to correct the first signal to the second signal is acquired under the following condition:
Temperature of the capacitance circuit CC is changed;
Control potential VF is changed; and
Light exposure is changed by changing exposure time under condition of constant illumination.

In the discussion of the third acquisition example, the temperature of the capacitance circuit CC may also be simply referred to as TMP.

In step S22, the imaging device 101 determines in the third acquisition example whether the control potential VF is above the specified potential. If the control potential VF is above the specified potential, processing proceeds to step S31. If the control potential VF is equal to or below the specified potential, processing returns to step S14.

In step S31, the temperature TMP of the capacitance circuit CC is updated to TMP=TMP+γ. In other words, TMP is increased by γ. In step S31, the control potential VF is reset to zero. In step S31, the exposure time T is reset to the initial value.

In step S32, the imaging device 101 determines whether the temperature TMP is a specified temperature. If the temperature TMP is above the specified temperature, processing proceeds to step S17. If the temperature TMP is equal to or below the specified temperature, processing returns to step S14.

Before proceeding to step S17, the light exposure is modified from the light exposure with the exposure time T being the initial value to the light exposure with the exposure time T being the specified time. The control potential VF is modified from zero to the specified potential at each light exposure. The temperature TMP is modified from the initial value to the specified temperature at each control potential VF. In step S17, the first data set having the value of the light exposure paired with the value of the first signal is obtained at each light exposure, at each control potential VF, and at each temperature TMP. In the example, herein, the light exposure to first signal level characteristics indicated by the first data set have the gamma characteristics.

In the third acquisition example, the first data set thus acquired is supplied in steps S17 and S18.

The third acquisition example may be applied to the examples illustrated in FIG. 28 and other figures. According to the third acquisition example, the correction tables in FIG. 29 and other figures are obtained.

Location where Correction Circuit is Mounted

The location where the correction circuits 504 and 509 are mounted is not limited to any location. In a first configuration example, the correction circuit 504 or 509 and the pixel array 501 are mounted on the same chip in the imaging device 101. In a second configuration example, the correction circuit 504 or 509 and the pixel array 501 are mounted on separate chips in the imaging device 101.

Configuration that Selects One of Configuration Tables

In one specific example, the non-volatile memory 505 stores multiple correction tables respectively corresponding to the control potentials VF. The correction circuit 504 includes a selector. The selector selects one of the correction tables in response to the value of the control potential VF. The correction circuit 504 corrects the first signal to the second signal using the selected correction table.

### Linear Interpolation Applicable in Correction

When the first signal is corrected to the second signal in accordance with the correction table, linear interpolation is applicable. For example, the correction table in FIG. 8 may now be used. The point where the value of the first signal is (An+1) and the value of the second signal is (An+1×C) may now be a first point. The point where the value of the first signal is (An+2) and the value of the second signal is (An+2×C) may now be a second point. The straight line passing through the first point and the second point is an imaginary straight line. If the value of the first signal is a Y value that is above An but below (An+1), the value of the second signal responsive to the Y value of the first signal may be identified by identifying the value of the second signal responsive to the value of the first signal being at the Y value on the imaginary straight line.

An example of the circuit configuration of an imaging device is described further. In the circuit configuration described below, the correction circuit 504 or 509 may also be employed.

### FOURTH EMBODIMENT

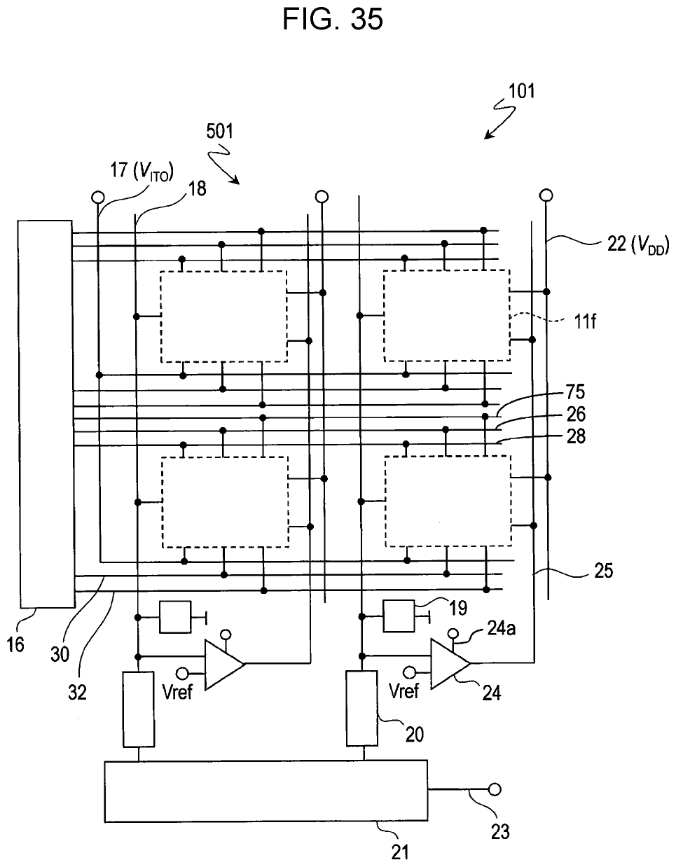

FIG. 35 is an exemplary schematic circuit diagram of an imaging device 101 of a fourth embodiment.

An inverting amplifier 24 is arranged on each vertical signal line 18. In the fourth embodiment, the inverting amplifiers 24 are included in a peripheral circuit.

A feedback control line 28 is arranged on each row of pixels 11f. The pixels 11f of each row are connected to the vertical scanning circuit 16 via the feedback control line 28. The vertical scanning circuit 16 supplies the feedback control line 28 with a predetermined potential, thereby forming a feedback circuit that causes the output of the pixel 11f to be negatively fed back.

A control line 32 is arranged on each row of the pixels 11f. Each row of the pixels 11f is connected to the vertical scanning circuit 16 via the corresponding control line 32. The vertical scanning circuit 16 may supply the pixels 11f with a predetermined potential.

A power supply line 22 is arranged on each column of the pixels 11f. The pixels 11f at each column are connected to the corresponding power supply line 22.

The negative input terminal of the inverting amplifier 24 is connected to the corresponding vertical signal line 18. The positive input terminal of the inverting amplifier 24 is supplied with a predetermined voltage Vref. The voltage Vref is a positive voltage as high as or closer to 1 V. Via the feedback line 25, the output terminal of the inverting amplifier 24 is connected to the pixels 11f that are connected to the negative input terminal of the inverting amplifier 24. The inverting amplifier 24 forms part of the feedback circuit that causes the pixel signal from the pixel 11f to be negatively fed back. The inverting amplifier 24 includes a gain adjustment terminal 24a that is used to vary inverting amplification gain.

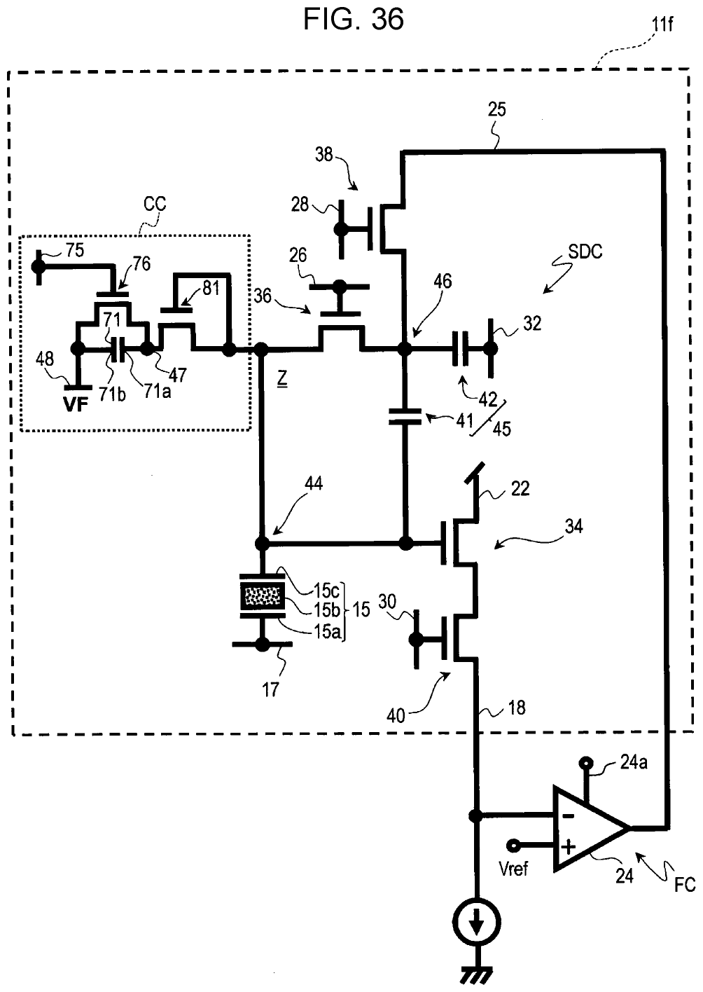

FIG. 36 is an exemplary schematic circuit diagram of one of the pixels illustrated in FIG. 35.

The pixel 11f includes a capacitance circuit 45 including a series connection of a capacitive element 41 and a capacitive element 42. The capacitance value of the capacitive element 42 is higher than the capacitance value of the capacitive element 41. The charge holding node 44 is connected to one of the source and the drain of the reset transistor 36, one electrode of the capacitive element 41, and the pixel electrode 15c.

A node 46 is connected to the other of the source and the drain of the reset transistor 36, the other electrode of the capacitive element 41, and one electrode of the capacitive element 42. The capacitive element 41 is connected in parallel with the reset transistor 36. The parallel connection may reduce a transistor junction leakage current to the charge holding node 44, thereby reducing dark current.

The other terminal of the capacitive element 42 is connected to the control line 32. The control line 32 may be used to control the potential of the other terminal of the capacitive element 42.

The pixel 1 if includes the feedback transistor 38. The node 46 is connected to the feedback line 25 via the feedback transistor 38. The gate of the feedback transistor 38 is connected to the feedback control line 28. Controlling the potential of the feedback control line 28 may form a feedback circuit FC that feeds back the output of the signal detection circuit SDC. Specifically, the feedback circuit FC causes the output of the signal detection circuit SDC to be negatively fed back.

Turning off the reset transistor 36 may cause kTC noise. The fourth embodiment may reduce the kTC noise.

### FIFTH EMBODIMENT

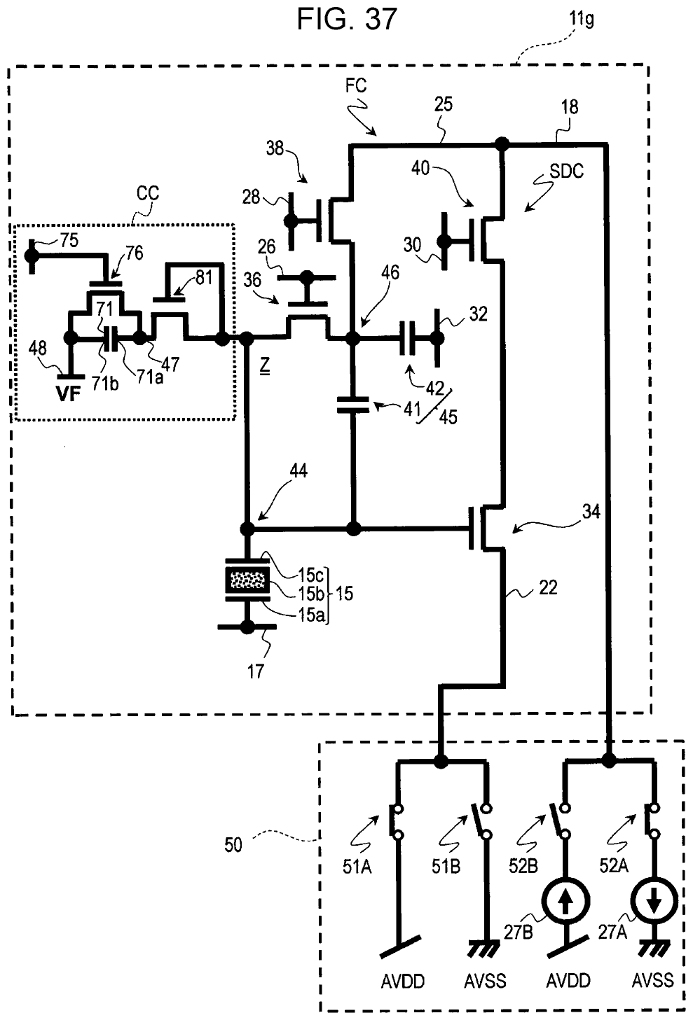

FIG. 37 is an exemplary schematic circuit diagram of a pixel 11g according to a fifth embodiment. The fifth embodiment is different from the fourth embodiment in that the fifth embodiment includes a switching circuit 50 in place of the inverting amplifier 24 at each column of pixels 11g. The feedback line 25 does not connect the pixels 11g forming each column in the pixel array 501 of the fifth embodiment.

In each pixel 11g, one of the source and the drain of the feedback transistor 38 is connected to the node 46. The other of the source and the drain of the feedback transistor 38 is connected to the feedback line 25. One of the source and the drain of the address transistor 40 is connected to the feedback line 25 and the vertical signal line 18. The other of the source and the drain of the address transistor 40 is connected to one of the source and the drain of the amplification transistor 34. The other of the source and the drain of the amplification transistor 34 is connected to the power supply line 22.

The switching circuit 50 includes switching elements 51A and 51B, switching elements 52A and 52B, and constant current power supplies 27A and 27B.

The switching elements 51A and 51B are connected to the power supply line 22. A power supply potential AVDD may be connected to the power supply line 22 via the switching element 51A. A reference potential AVSS may be connected to the power supply line 22 via the switching element 51B.

The switching elements 52A and 52B are connected to the vertical signal line 18. The reference potential AVSS may be connected to the vertical signal line 18 via the constant current power supply 27A and the switching element 52A in this order. The power supply potential AVDD may be connected to the vertical signal line 18 via the constant current power supply 27B and the switching element 52B in this order.

During signal reading, a voltage is applied to the gate of the address transistor 40 via the address signal line 30. In this way, one pixel 11g is selected from each column of the pixels 11g. By turning on the switching elements 51A and 52A in the switching circuit 50, a current flows from the constant current power supply 27A in a direction from the amplification transistor 34 to the address transistor 40 and a potential of the charge storage region Z that is amplified by the inverting amplifier 24 is thus detected.

During reset operation, the switching element 51B and the switching element 52B in the switching circuit 50 are turned on. In this way, a current flow through the address transistor 40 and the amplification transistor 34 in a direction reverse to the current direction during the signal reading. This leads to forming the feedback circuit FC including the amplification transistor 34, the address transistor 40, the feedback line 25, the feedback transistor 38, and the reset transistor 36. The kTC noise may thus be cancelled.

### SIXTH EMBODIMENT

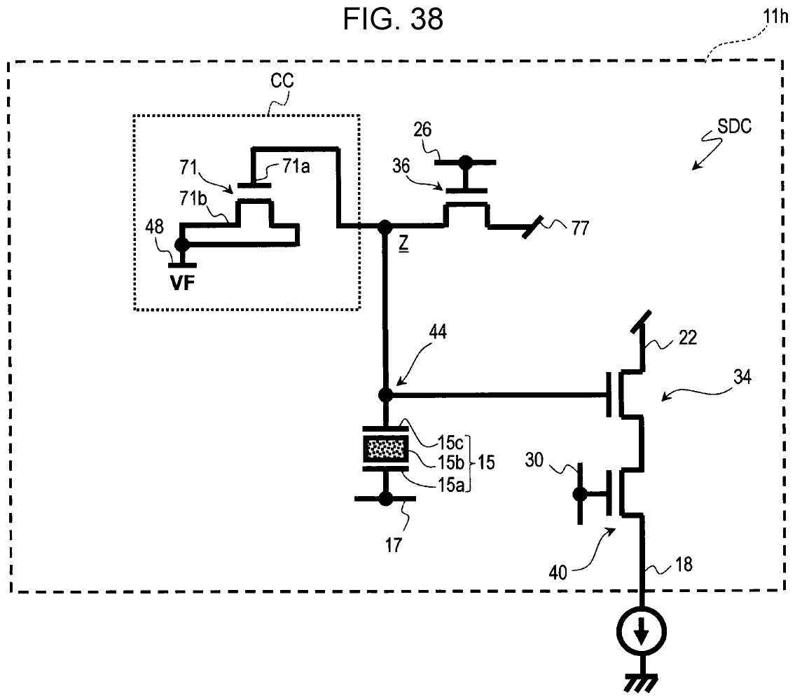

FIG. 38 is an exemplary schematic circuit diagram of a pixel 11h according to a sixth embodiment. The first capacitive element 71 in the pixel 11h is a metal-oxide semiconductor (MOS) capacitor. In the following discussion, the first capacitive element 71 is occasionally referred to as a MOS capacitor 71.

The capacitance circuit CC in the sixth embodiment includes the first voltage supply circuit 48 and the MOS capacitor 71. The first capacitive element 71 is connected between the first voltage supply circuit 48 and the charge storage region Z.

The charge holding node 44 connects to the first terminal 71a of the MOS capacitor 71, the gate of the amplification transistor 34, and the pixel electrode 15c of the photoelectric converter 15.

The use of the MOS capacitor as the first capacitive element 71 may implement the capacitance circuit CC using a smaller number of elements. This may be effective from the point of view of reducing the size of the pixel 11h and improving resolution. If the first capacitive element 71 as a MOS capacitor and the amplification transistor 34 as a MOS transistor are used, the first capacitive element 71 and the amplification transistor 34 may be manufactured through a common manufacturing process. This may be effective from the point of view of reducing manufacturing costs.

In the sixth embodiment, the first capacitive element 71 is implemented using a transistor. One of the first terminal 71a and the second terminal 71b is connected to the source and the drain of the transistor. The other of the first terminal 71a and the second terminal 71b is connected to the gate of the transistor. Referring to FIG. 38, the second terminal 71b is connected to the source and the drain of the transistor. The first terminal 71a is connected to the gate of the transistor.

The source and the drain of the transistor are connected to each other. In this configuration, the transistor is turned on when a difference occurs between the potential of the first terminal 71a and the potential of the second terminal 71b of the MOS capacitor 71. The source and the drain of the transistor may be connected to each other via a wiring or the like.

The operation of the imaging device 101 of the sixth embodiment is described below. In the following discussion, the term “inter-terminal voltage of the MOS capacitor 71” is used. The inter-terminal voltage refers to the difference between the potential of the first terminal 71a and the potential of the second terminal 71b of the MOS capacitor 71.

The second terminal 71b of the MOS capacitor 71 is supplied with the control potential VF. When photoelectric conversion is performed by the photoelectric converter 15, the potential of the first terminal 71a included in the charge storage region Z varies, thereby varying the inter-terminal voltage. Specifically, the signal charges are holes, and if the photoelectric conversion is performed by the photoelectric converter 15, the potential of the first terminal 71a rises. When the inter-terminal voltage reaches a specific value, the transistor is turned on. In this way, the MOS capacitor 71 turns active as a capacitance. The capacitance value of the charge storage region Z thus increases.

The control potential VF applied to the second terminal 71b may be changed. For example, imaging modes of the imaging device 101 include a first mode and a second mode. In the first mode, the control potential VF applied to the second terminal 71b is the potential VFA. In the second mode, the control potential VF applied to the second terminal 71b is the potential VFB. The potential VFA and the potential VFB are different from each other. In this example, a difference may be introduced between the first threshold potential in the first mode and the first threshold potential in the second mode.

With the first capacitive element 71 being a MOS capacitor, the capacitance value of the charge storage region Z varies in a stepwise manner when the potential of the charge storage region Z varies across the first threshold potential. Alternatively, however, the capacitance value of the charge storage region Z may continuously vary when the potential of the charge storage region Z varies across the first threshold potential. A first description, a second description, and a third description related to the previous embodiments refer to these settings. The first description signifies that the capacitance circuit CC varies the capacitance value of the charge storage region Z when the potential of the charge storage region Z varies across the first threshold potential. The second description signifies that the capacitance circuit CC varies the capacitance value of the charge storage region Z in response to the capacitance value of the first capacitive element 71. The third description signifies that the capacitance circuit CC varies the capacitance value of the charge storage region Z by the capacitance value of the first capacitive element 71 in response to the potential of the charge storage region Z.

### SEVENTH EMBODIMENT

FIG. 39 is an exemplary schematic circuit diagram of a pixel 11j according to a seventh embodiment.

In the pixel 11j of the seventh embodiment, different from the pixel 11a of the first embodiment, the photoelectric converter 15 is a photodiode. Specifically, the photoelectric converter 15 is a silicon photodiode. The signal charges are electrons. The configuration and operation of the capacitance circuit CC are identical to those of the first embodiment and the discussion thereof is omitted herein.

### EIGHTH EMBODIMENT

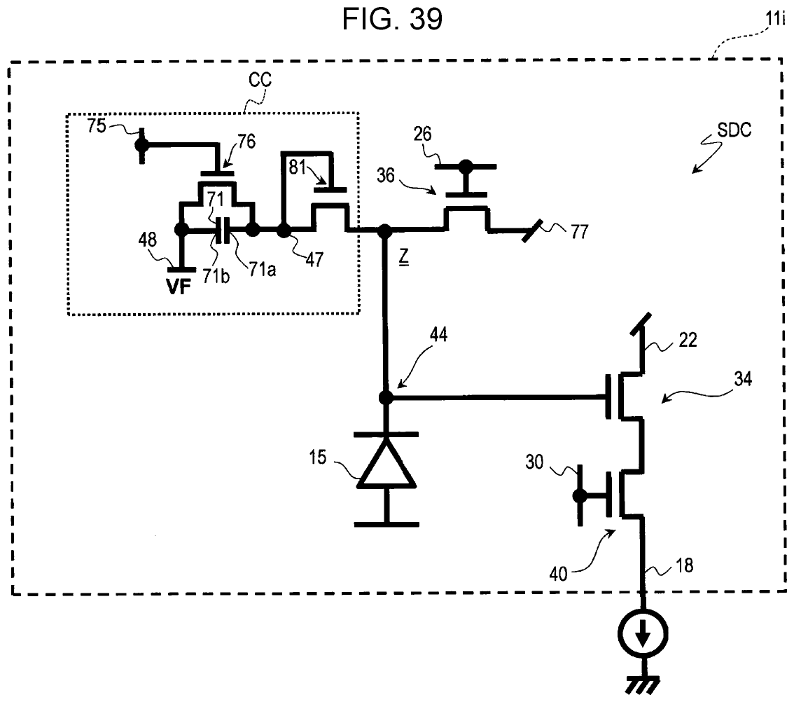

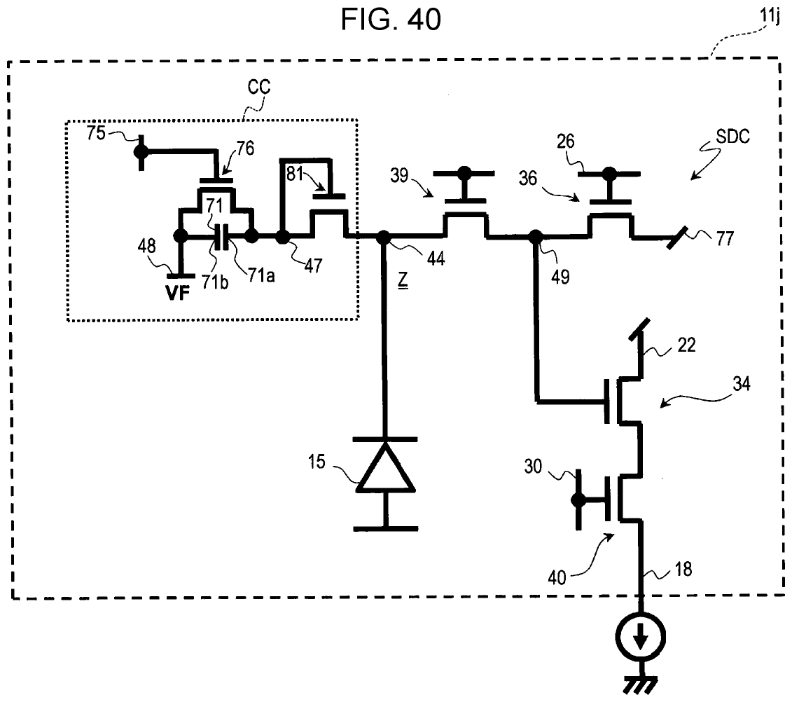

FIG. 40 is an exemplary schematic circuit diagram of a pixel 11j according to an eighth embodiment.

The pixel 11j of the eighth embodiment, different from the pixel 11i of the seventh embodiment, includes a transfer transistor 39. One of the source and the drain of the transfer transistor 39 is connected to the gate of the amplification transistor 34. The one of the source and the drain of the transfer transistor 39 is connected to one of the source and the drain of the reset transistor 36. The other of the source and the drain of the transfer transistor 39 is connected to the charge holding node 44. When the transfer transistor 39 is turned on, signal charges accumulated in the charge storage region Z are transferred to the node 49 and a pixel signal responsive to the potential of the node 49 is thus output from the amplification transistor 34.

### NINTH EMBODIMENT

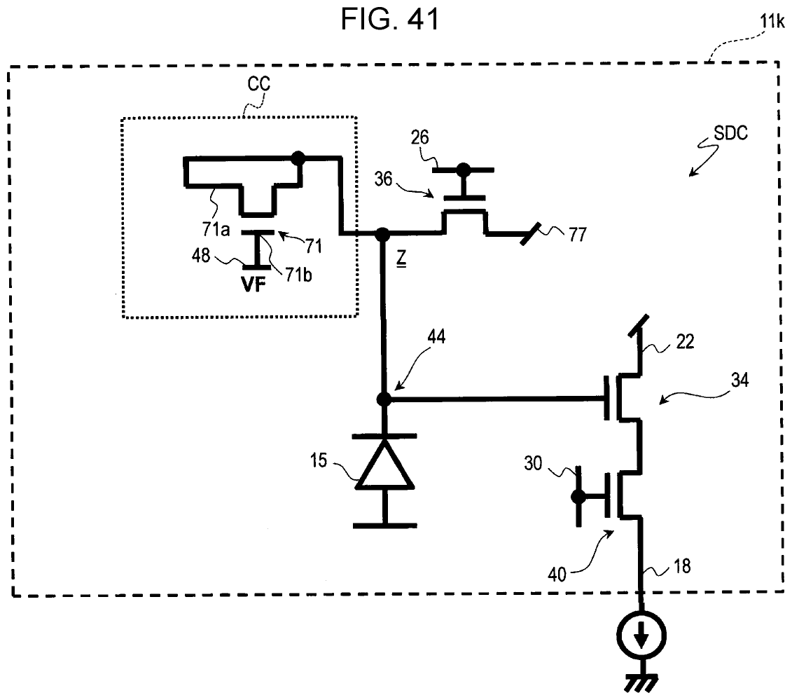

FIG. 41 is an exemplary schematic circuit diagram of a pixel 11k according to a ninth embodiment.

The circuit configuration of the pixel 11k of the ninth embodiment in FIG. 41 is different from the circuit configuration of the pixel 11i of the seventh embodiment in FIG. 39 in terms of the capacitance circuit CC. In the ninth embodiment, the first capacitive element 71 is a MOS capacitor.

The charge holding node 44 connects to the first terminal 71a of the MOS capacitor 71, the gate of the amplification transistor 34, and the photoelectric converter 15. The photoelectric converter 15 is a photodiode. The configuration and operation of the capacitance circuit CC are identical to those of the sixth embodiment and the discussion thereof is omitted herein.

### OTHER EMBODIMENTS

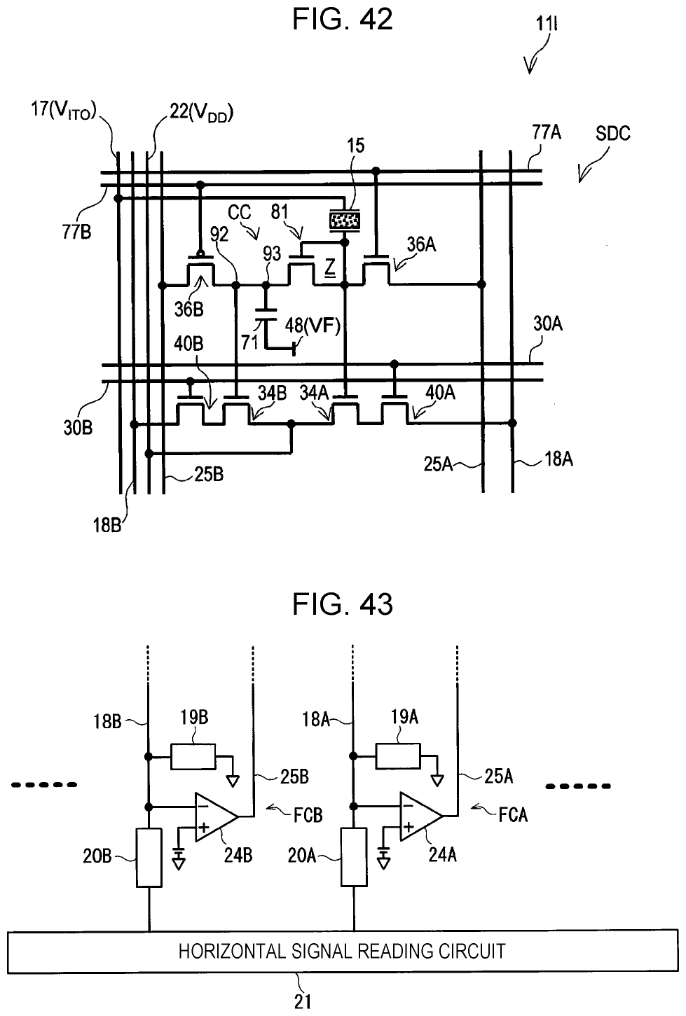

The configurations of the pixel employing the capacitance circuit CC are not limited to those described above. If a correction circuit includes the capacitance circuit CC with the capacitance value of the charge storage region Z varying in response to the potential of the charge storage region Z, such a correction circuit is acceptable. For example, the correction circuit included in each of pixels illustrated in FIGS. 42 through 45 is acceptable.

The pixel 111 in FIGS. 42 and 43 includes not only a first amplification transistor 34A that outputs a pixel signal responsive to the potential of the charge storage region Z but also a second amplification transistor 34B that outputs a pixel signal responsive to a potential of nodes 92 and 93 between the first transistor 81 and the first capacitive element. The first amplification transistor 34A, first address transistor 40A, first reset transistor 36A, first transistor 81, second amplification transistor 34B, and second address transistor 40B are N-type transistors. A second reset transistor 36B is a P-type transistor. The output of the first amplification transistor 34A is negatively fed back via a first inverting amplifier 24A and a feedback line 25A. The output of the second amplification transistor 34B is negatively fed back via a second inverting amplifier 24B and a feedback line 25B. In this configuration, reset noise that is generated when the first reset transistor 36A and the second reset transistor 36B are turned off may be reduced.

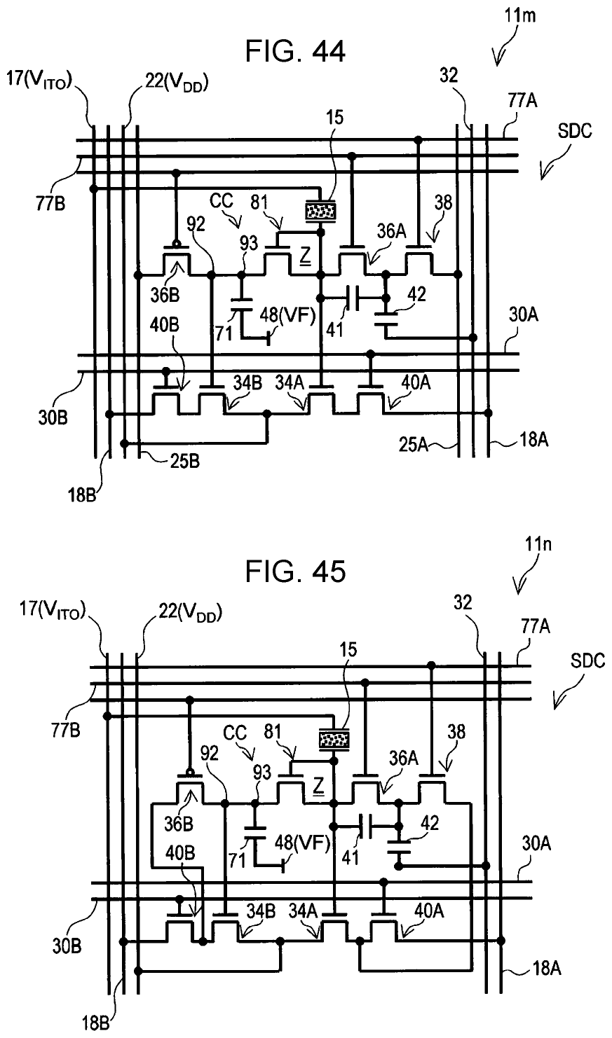

A pixel 11m illustrated in FIG. 44 is different from the pixel 111 illustrated in FIG. 42 in that the pixel 11m additionally includes the feedback transistor 38 and the capacitive elements 41 and 42. The feedback transistor 38 is an N-type transistor. The pixel 11m illustrated in FIG. 44 may even further reduce the reset noise caused by the reset transistor 36A.

A pixel 11n in FIG. 45 is different from the pixel 11m illustrated in FIG. 44 in that the pixel 11n includes a path for negative feedback therewithin. In the pixel 11n, one of the source and the drain of the feedback transistor 38 is connected to the node between an amplification transistor 34A and a selection transistor 40A. One of the source and the drain of a reset transistor 36B is connected to the node between an amplification transistor 34B and a selection transistor 40B. A power supply line 22 is supplied with at least two different voltages. The pixel 11n in FIG. 45 not only may reduce the reset noise but also may simplify circuit configuration.

A camera system related to the disclosure may be applicable to a variety of camera systems and sensor systems, including digital still cameras, broadcast cameras, professional cameras, medical cameras, monitoring cameras, car cameras, digital single-lens reflex cameras, and digital mirror-less single-lens reflex cameras.

What is claimed is:

1. An imaging device comprising:
a first pixel and a second pixel; and
a correction circuit that receives first signals respectively corresponding to the first pixel and the second pixels and that outputs second signals in response to the first signals, wherein
each of the first pixel and the second pixel includes:
a photoelectric converter that converts light into signal charges;
a charge storage region that stores the signal charges; and
a capacitance circuit that varies a capacitance value of the charge storage region in response to a potential of the charge storage region, and
the correction circuit corrects the first signal of at least one of the first pixel or the second pixel to the second signal such that a difference between the second signal of the first pixel and the second signal of the second pixel is less than a difference between the first signal of the first pixel and the first signal of the second pixel in a case where a same amount of light is incident on the first pixel and the second pixel.

2. The imaging device according to claim 1, wherein the correction circuit corrects the first signal of at least one of the first pixel or the second pixel to the second signal such that the second signal is linear with respect to an amount of incident light.

3. The imaging device according to claim 1, wherein
the capacitance circuit comprises:
a voltage supply circuit; and
a transistor and a capacitor that are connected in series between the voltage supply circuit and the charge storage region, and
a gate of the transistor is connected to the charge storage region.

4. The imaging device according to claim 3, wherein the voltage supply circuit, the capacitor, the transistor, and the charge storage region are connected in series in this order.

5. The imaging device according to claim 3, wherein the voltage supply circuit, the transistor, the capacitor, and the charge storage region are connected in series in this order.

6. The imaging device according to claim 1, wherein
the capacitance circuit comprises:
a voltage supply circuit; and
a metal-oxide-semiconductor (MOS) capacitor that is connected between the voltage supply circuit and the charge storage region.

7. The imaging device according to claim 1, wherein the correction circuit corrects the first signal of at least one of the first pixel or the second pixel to the second signal by using a correction table that associates the first signal with the second signal.

8. The imaging device according to claim 1, wherein the correction circuit corrects the first signal of at least one of the first pixel or the second pixel to the second signal by using a function that defines a relationship between the first signal and the second signal.

9. A signal processing method outputting second signals in response to first signals respectively corresponding to a first pixel and a second pixel, each of the first pixel and the second pixel including a capacitance circuit that varies, in response to a potential of a charge storage region that stores signal charges, a capacitance value of the charge storage region, the signal processing method comprising:
inputting the first signals respectively corresponding to the first pixel and the second pixel;
correcting the first signal of at least one of the first pixel or the second pixel to the second signal such that a difference between the second signal of the first pixel and the second signal of the second pixel is less than a difference between the first signal of the first pixel and the first signal of the second pixel in a case where a same amount of light is incident on the first pixel and the second pixel; and
outputting the second signals respectively corresponding to the first pixel and the second pixel.

10. The signal processing method according to claim 9, further comprising correcting the first signal of at least one of the first pixel or the second pixel to the second signal such that the second signal is linear with respect to an amount of incident light.
